(19) United States
(12) Patent Application Publication
(10) Pub. No.: US 2010/0223477 A1
(43) Pub. Date: Sep. 2, 2010

(54) CONTENT REPRODUCING DEVICE, CONTENT REPRODUCING METHOD, RECORDING MEDIUM, AND INTEGRATED CIRCUIT

(76) Inventors: Senichi Onoda, Osaka (JP); Toshihisa Nakano, Osaka (JP); Shunji Harada, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/679,349

(22) PCT Filed: Oct. 15, 2008
(86) PCT No.: PCT/JP2008/002918

§ 371 Date: Mar. 22, 2010

(30) Foreign Application Priority Data
Oct. 17, 2007 (JP) 2007 269921

(51) Int. Cl. G06F 21/24; G06F 17/00

(52) U.S. Cl. 713/189; 700/94

(57) ABSTRACT

A content playback apparatus (digital watermark detection apparatus) comprises: a detection unit operable to detect a digital watermark from audio data having a plurality of blocks, the audio data being contained in a content which is to be played back along a playback time-line; a detected block storage unit for storing therein information indicating a block in which the digital watermark has been detected by the detection unit; and a playback control unit operable to play back all data contained in the content other than audio data corresponding to the block indicated by the information stored in the detected block storage unit. This makes it possible, even when audio data containing copyright information is inadvertently recorded on a camcorder, to prevent the audio data containing the copyright information from being played back, thereby enabling users to view the content without the influence of playback control.

### TECHNICAL FIELD

The present invention relates to a technique for protecting digital contents, such as music and movies, against unauthorized copying, and particularly relates to a technique using digital watermarks for the protection.

### BACKGROUND ART

In recent years, along with the development of large-capacity recording media and broadband networks, a system for distributing a digital content is becoming popular. In such a system, a digital content (hereafter simply referred to as “a content”), which is a digitized work, such as a movie or a piece of music, is distributed via a recording medium, or distributed via a broadband network.

In such a system, in order to protect a copyright for the content, it is required that copying and playback of the content be permitted only under restrictions based on an agreement with a copyright holder. As a conventional technique for protecting a copyrighted work against unauthorized copying that is not permitted by a copyright holder, a method using digital watermarks is well known. A common system using digital watermarks includes a terminal at a content provider's end (a digital watermark embedding apparatus), and a playback terminal at a content user's end (a digital watermark detection apparatus).

In the system, the terminal at the content provider's end (the digital watermark embedding apparatus) embeds copyright information or the like in the content, and thereafter records the content on a recording medium such as a disc. On the other hand, the playback terminal at the content user's end (the digital watermark detection apparatus) detects digital watermarks from the content that has been recorded on the recording medium, and controls the playback of the content based on the copyright information included in the digital watermarks.

In the system, if a content in which copyright information and the like has been embedded is copied without authorization, this means that the copyright information is also copied. Therefore, by detecting the copyright information, it becomes possible to judge whether the content has been copied without authorization, and to control the playback of the content (e.g. when judged the content is an unauthorized copy, to stop).

The digital watermark technique is described in details in Patent Documents 2 and 3. Patent Document 1 also discloses a technique for preventing unauthorized copying, by embedding copy control information in a content using the digital watermark technique.

### [Patent Document]

Patent Document 1: U.S. Pat. No. 5,943,422
Patent Document 2: Japanese Patent Application Publication No. H09-191394
Patent Document 3: Japanese Patent Application Publication No. H09-191395

### DISCLOSURE OF INVENTION

### Technical Problem

However, the above system that provides copyright protection by means of digital watermarks could even be disadvantageous to users who do not commit unauthorized acts. As to this point, description will be made below with reference to concrete examples.

In recent years, digital video cameras (hereinafter referred to as “camcorders”) have been becoming popular as apparatuses for recording video data for personal purposes, such as to make a record of a child's growth. A camcorder is capable of recording video data digitally on a recording medium (such as an optical disc, including a DVD and an SD memory card), and users can easily play back and enjoy the video recorded on the recording medium using a playback apparatus (such as a DVD recorder).

Now, consider a case where a DVD of a children's favorite movie, such as an animation movie, is played back using a playback terminal at a birthday party, and the party with the movie audible in the background is recorded on a camcorder.

In such a case, if copyright information has been embedded in the audio part of the movie by digital watermarking, the camcorder inevitably records, on a recording medium, the audio information embedded with the digital watermarks, in addition to the images and voices of the children.

When such a recording medium is played back, the playback terminal detects the digital watermarks from the audio information. Consequently, due to a copyright protection function of the playback terminal, the video of the birthday party is misjudged to be an unauthorized copy of the movie. This makes the playback terminal perform various playback control operations, causing audio output to stop (i.e. mute) or a warning to appear on a screen, for example.

Thus, there is a problem that the person who recorded the video may not replay the recorded video of an importance as usual, despite that he or she did not commit unauthorized acts. Moreover, a similar problem occurs in other situations, such as when an event or an athletic meeting is recorded in which a piece of music embedded with digital watermarks is being played back as BGM.

In view of the above problem, the object of the present invention is to provide a content playback apparatus, a content playback method, a recording medium, and an integrated circuit, all of which makes it possible to avoid disadvantages to users who do not commit unauthorized acts in a system that provides copyright protection by means of digital watermarking.

### Technical Solution

In order to achieve the above object, one aspect of the present invention is a content playback apparatus, comprising: a detection unit operable to detect a digital watermark from audio data having a plurality of blocks, the audio data being contained in a content which is to be played back along a playback time-line; a detected block storage unit for storing therein information indicating a block in which the digital watermark has been detected by the detection unit; and a playback control unit operable to play back all data contained in the content other than audio data corresponding to the block indicated by the information stored in the detected block storage unit.

### ADVANTAGEOUS EFFECTS

With the above structure, since the audio data in the block embedded with copyright protection information (i.e. the digital watermark information that instructs playback control) is not to be played back, the present invention makes it possible to view all data contained in the content other than the audio data that is not to be played back.

For example, when the content is composed of audio data and image data, users are able to listen to all the audio data contained in the content other than the audio data that is not to be played back, and watch all the video data contained in the content.

This allows suppressing disadvantages to users who do not commit unauthorized acts.

### BRIEF DESCRIPTION OF DRAWINGS

FIG. 1 is a block diagram showing a structure of a digital watermark embedding/detection system according to a first embodiment.

FIG. 2 is a block diagram showing a content data generation apparatus (digital watermark embedding apparatus) according to the first embodiment.

FIG. 3 is a block diagram showing a content playback/editing apparatus (digital watermark detection apparatus) according to the first embodiment.

FIG. 4 is a block diagram showing a structure of a judgment unit of the content playback/editing apparatus according to the first embodiment.

FIG. 5 shows an example of watermark information recorded in a detection result storage unit according to the first embodiment.

FIG. 6 is a flowchart showing operations of digital watermark embedding processing according to the first embodiment.

FIG. 7 is a flowchart showing operations of digital watermark detection processing according to the first embodiment.

FIG. 8 is a flowchart showing operations of judgment processing according to the first embodiment.

FIG. 9 is a flowchart showing editing operations of the content playback/editing apparatus (digital watermark detection apparatus) according to the first embodiment.

FIG. 10 is block diagram showing a structure of a judgment unit of the content playback/editing apparatus (digital watermark detection apparatus) according to the second embodiment.

FIG. 11 shows an example of the watermark information stored in a detection result storage unit according to the second embodiment.

FIG. 12 is a flowchart showing operations of judgment processing according to the second embodiment.

FIG. 13 shows an example of various operations performed in one-to-one correspondence with various types of the watermark information.

FIG. 14 shows an example of watermark information detection timing and operation start at the detection.

FIG. 15 is a block diagram showing a content playback/editing apparatus (digital watermark detection apparatus) according to the second embodiment.

FIG. 16 shows an example of the information stored in a digital watermark detected block storage unit according to the first embodiment.

FIG. 17 is a view that explains deletion processing of certain blocks contained in a content according to the first embodiment.

FIG. 18 shows an example of the information stored in a digital watermark detected block storage unit according to the second embodiment.

FIG. 19 is a flowchart showing special playback operations of the content playback/editing apparatus (digital watermark detection apparatus) according to the second embodiment.

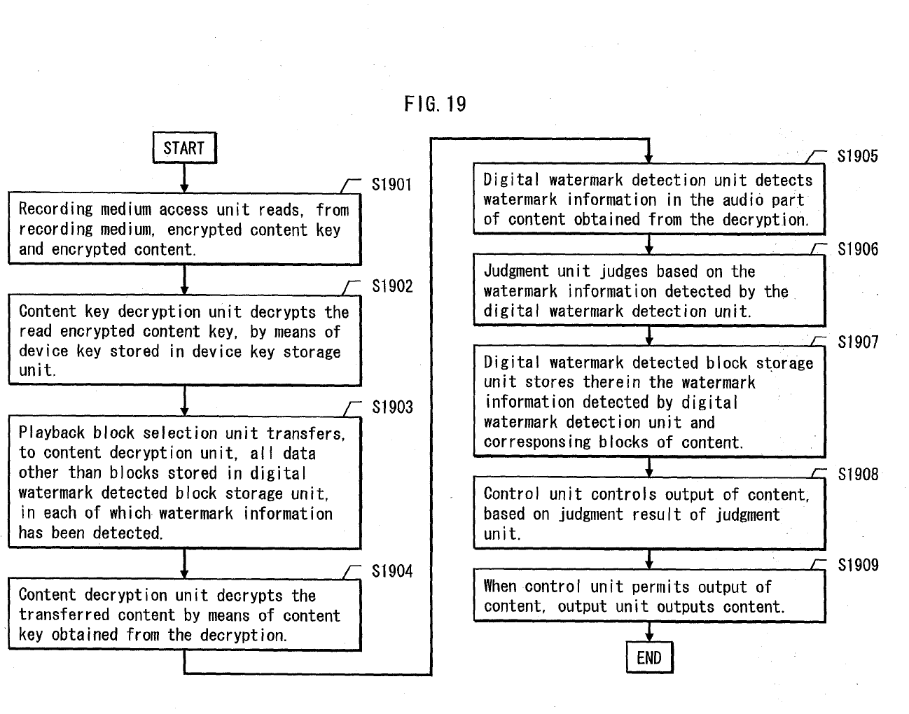

### EXPLANATION OF REFERENCE

109 content generation apparatus (digital watermark embedding apparatus)
102 content playback/editing apparatus (digital watermark detection apparatus)
103 recording medium
201 content storage unit
202 embedding information generation unit
203 digital watermark embedding unit
204 content encryption unit
205 content key storage unit
206 device key storage unit
207 content key encryption unit
208 output unit
301 recording medium access unit
302 device key storage unit
303 content key decryption unit
304 content decryption unit
305 digital watermark detection unit
306 judgment unit
307 control unit
308 output unit
309 digital watermark detected block storage unit
310 digital watermark detected block deletion unit
311 content encryption unit
401 detection result storage sub-unit
402 comparison sub-unit
403 update sub-unit
404 control condition judgment sub-unit
1001 detection result storage sub-unit
1002 update sub-unit
1003 control condition judgment sub-unit
1501 playback block selection unit

### BEST MODE FOR CARRYING OUT THE INVENTION

One aspect of the present invention as recited in claim 1 is a content playback apparatus, comprising: a detection unit operable to detect a digital watermark from audio data having a plurality of blocks, the audio data being contained in a content which is to be played back along a playback time-line;

a detected block storage unit for storing therein information indicating a block in which the digital watermark has been detected by the detection unit; and
a playback control unit operable to play back all data contained in the content other than audio data corresponding to the block indicated by the information stored in the detected block storage unit.

In another aspect of the present invention as recited in claim 2, the playback control unit includes a deletion unit operable to delete, from the content, the audio data corresponding to the block indicated by the information stored in the detected block storage unit; and a playback unit operable to play back all data contained in the content other than the deleted audio data.

With the above structure, the audio data corresponding to the blocks embedded with copyright protection information (i.e. the digital watermark information that instructs playback control) is deleted. Consequently, all data contained in the content other than the deleted audio data can be viewed tows usual, without the influence of a copyright protection mechanism

In yet another aspect of the present invention as recited in claim 3, the playback control unit includes a deletion unit operable to replace the audio data corresponding to the block indicated by the information stored in the detected block storage unit with other audio data; and a playback unit operable to play back the other data and all data contained in the content other than the replaced audio data.

Now then, in such a case that the audio data corresponding to the blocks is deleted before being played back, content users might face an unpleasant experience where audio output suddenly stops while viewing the content.

On the other hand, with the above structure, not the audio data included in the recorded content but other audio data is output. This allows preventing users from facing an unpleasant experience where no audio data is output while viewing the content.

In another aspect of the present invention as recited in claim 4, the playback control unit includes a playback block selection unit operable to select all data contained in the content other than the audio data corresponding to the block indicated by the information stored in the detected block storage unit, by skipping the audio data corresponding to the block; and a playback unit operable to play back the selected data.

With the above structure, some of the audio data corresponding to the blocks embedded with copyright protection information (i.e. the digital watermark information that instructs playback control) is skipped during playback. This allows users to view all data contained in the content other than the skipped audio data as usual, without the copyright protection mechanism being put into action.

Another aspect of the present invention as recited in claim 5 is a content playback apparatus, comprising: a detection unit operable to detect a digital watermark from audio data having a plurality of blocks, the audio data being contained in a content which is to be played back along a playback time-line; a detected block storage unit for storing therein information indicating blocks in each of which the digital watermark has been detected by the detection unit; and a condition storage unit that stores therein a prescribed condition for playback control to be executed; and a playback control unit operable to (i) select a block from among blocks in each of which the digital watermark has been detected, the block to be selected being indispensable for the prescribed condition to be satisfied, and (ii) play back all data contained in the content other than audio data corresponding to the selected block.

With the above structure, even a block in which the digital watermark information has been detected can be played back, as long as the block does not satisfy the prescribed condition for the execution of the playback control. This allows minimizing the number of the blocks that are not be played back.

Users are able to view all data contained in the content as usual other than the audio data that is not to be played back, which suppress disadvantages to users who do not commit unauthorized acts.

In another aspect of the present invention as recited in claim 6, the detected section storage unit stores therein blocks in each of which the digital watermark has been detected, and the prescribed condition is that, in a predetermined number of timely consecutive blocks, the digital watermark has been detected in more blocks than a predetermined threshold.

For example, it is assumed that the prescribed condition that “playback control is to be executed if the digital watermark information has been detected in two of five blocks included in the content” is stored in the condition storage unit. In this case, since the prescribed condition is not satisfied if one of the two blocks in which the digital watermark information has been detected is not played back, it is not necessary to execute such playback control that both the two blocks in five are not to be played back.

As a result, the playback control unit only needs to select one of the two blocks and perform such control that the selected block is not to be played back. This enables users to view the content as much as possible only if outside of a range of the prescribed condition.

### First Embodiment

### <1.1> Structure of Digital Watermark Embedding/Detection System

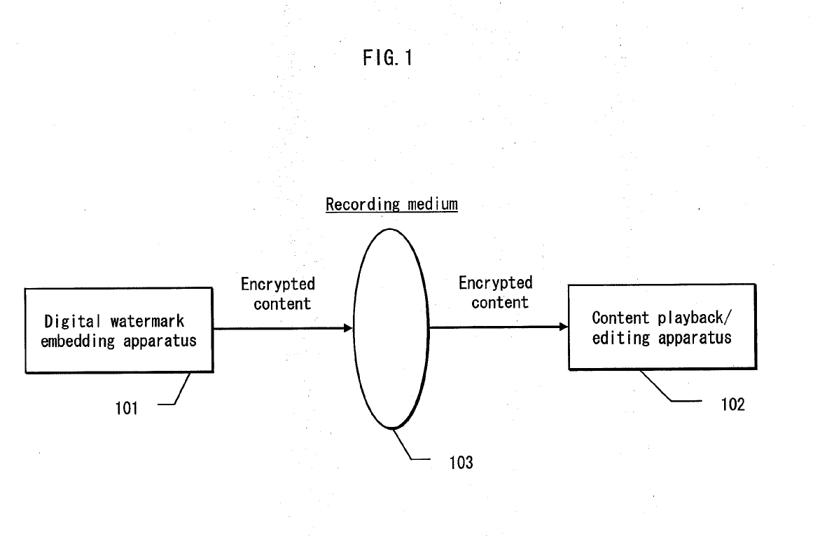

As shown in FIG. 1, a digital watermark embedding/detection system includes a content data generation apparatus (digital watermark embedding apparatus) 101, a content playback/editing apparatus (digital watermark detection apparatus) 102, and a recording medium 103. Description will be made on each of the compositional elements below.

The content data generation apparatus (digital watermark embedding apparatus) 101 embeds digital watermarks (referred to as watermark information below) in a content, encrypts the content, and records the encrypted content on a recording medium 103.

The content playback/editing apparatus (digital watermark detection apparatus) 102 reads the content that has been encrypted (referred to as an encrypted content below) from the recording medium 103, decrypts the content, and checks whether the watermark information is embedded in the decrypted content. If the watermark information is detected, the content playback/editing apparatus (digital watermark detection apparatus) 102 controls the playback of the content according to the detected watermark information.

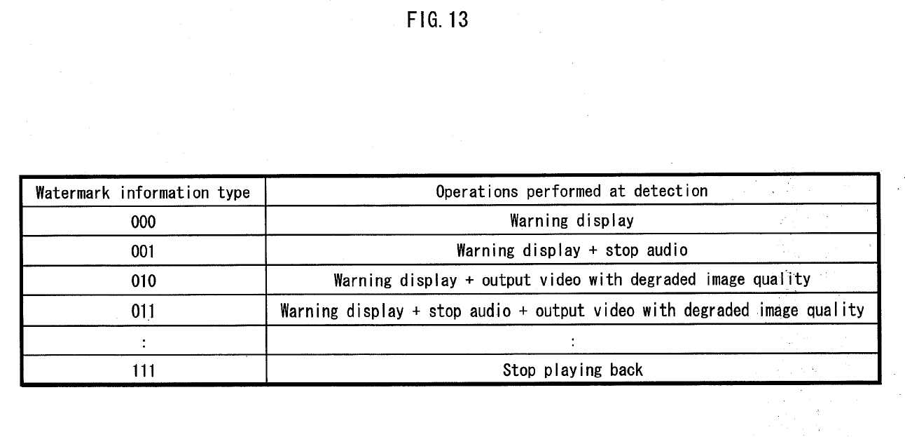

Note that the audio part of the content is divided into a plurality of blocks, for each of which digital watermark detection is to be performed, and a watermark information piece corresponding to a desired operation (e.g. a playback interruption) may be embedded in each block in the present invention. Further, the content playback/editing apparatus (digital watermark detection apparatus) 102 executes playback control on the content, in accordance with the type and a detection frequency of the detected watermark information. FIG. 13 shows an example.

FIG. 13 is a table showing various types of watermark information, in correspondence with the operations that the content playback/editing apparatus (digital watermark detection apparatus) 102 performs when detecting each of the information. The table is held in the content playback/editing apparatus (digital watermark detection apparatus) 102, and used for playback control on the content.

Holding a table as shown in FIG. 13, the content playback/editing apparatus (digital watermark detection device) 102 displays a warning showing that the content is unauthenticated, when detecting “000” as watermark information, and stops playing back the content, when detecting “111” as watermark information.

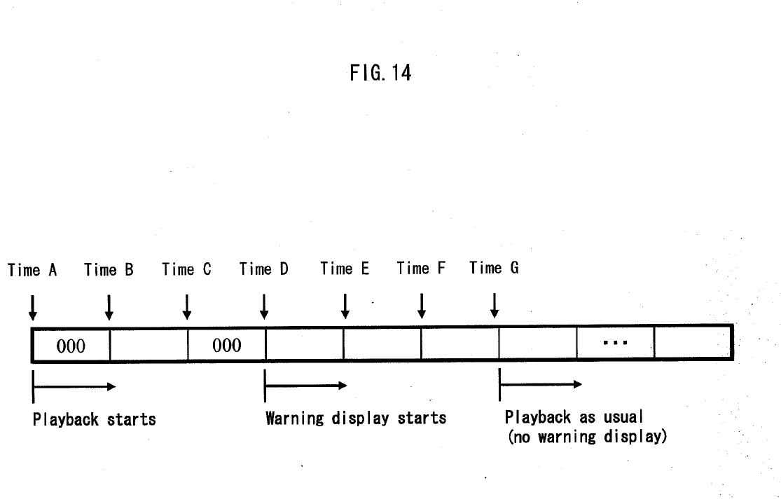

Besides, the playback control of the content playback/editing apparatus (digital watermark detection apparatus) 102 after the detection of watermark information is thought to be performed (i) immediately after the detection of watermark information, or (ii) when a prescribed playback control condition (e.g. a threshold value) is satisfied. As an example, it is envisaged that a control operation is executed when the watermark information “000” has been detected in more than two blocks among the most recent past five blocks for which the existence or non-existence of watermark information has been already confirmed. FIG. 14 shows an example.

In the FIG. 14 example, the content playback/editing apparatus (digital watermark detection apparatus) 102 detects the watermark information “000” in a period between time A and time B. However, since the condition that “when two or more watermark information pieces have been detected” is not satisfied in that period, a “warning display” operation is not to be executed.

However, in a period between time C and time D, since the condition is satisfied due to the second watermark information “000” being detected, the “warning display” operation is to be executed.

Further, in a period between time D and time E and a period between time E and time F, no watermark information is detected. However, since the condition that “when watermark information has been detected in more than two blocks in the past five blocks” remains satisfied in those periods, the “warning display” operation is continuously executed.

Subsequently in a period between time F and time G, when no watermark information is detected in a corresponding block, the condition that “when watermark information has been detected in more than two blocks in the past five blocks” does not hold. Accordingly, the “warning display” operation is to be cancelled, and normal playback is to be resumed.

Meanwhile, there is a possibility that various types of watermark information can be detected at the time of the playback of a single disc on which the birthday party has been recorded. For example, several movies might have been played at the birthday party, and even in a single movie different kinds of playback control might have been performed for each scene. In such a case, an operation corresponding to one type of watermark information that has been selected according to a prescribed condition is performed, in the first embodiment. This will be later explained in <1.4> in details.

### <1.2> Structure of Content Data Generation Apparatus (Digital Watermark Embedding Apparatus) 101

Next, description will be made on the structure of the content data generation apparatus (digital watermark embedding apparatus) 101 in details.

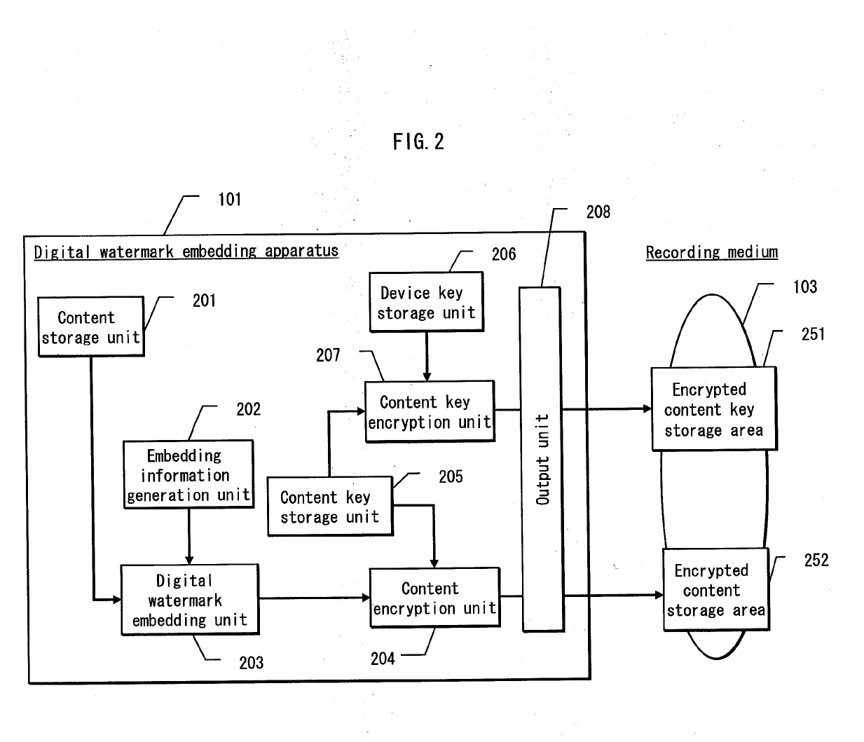

As shown in FIG. 2, the content data generation apparatus (digital watermark embedding apparatus) 101 includes a content storage unit 201, an embedding information generation unit 202, a digital watermark embedding unit 203, a content encryption unit 204, a content key storage unit 205, a device key storage unit 206, a content key encryption unit 207, and an output unit 208. Although not shown, the content data generation apparatus (digital watermark embedding apparatus) 101 further includes an input unit and the like (e.g. a remote control or a button) that receives an input from the outside, such as a user.

More specifically, the content data generation apparatus (digital watermark embedding apparatus) 101 includes a microprocessor, a RAM, a ROM, a hard disk, and others, all of which are not shown. The RAM, the ROM and the hard disk store therein a computer program. The watermark embedding apparatus 101 fulfills functions thereof due to the microprocessor operating in accordance with the computer program.

In the digital watermark embedding apparatus 101, each of the functional blocks, namely the content storage unit 201, the embedding information generation unit 202, the digital watermark embedding unit 203, the content encryption unit 204, the content key storage unit 205, the device key storage unit 206, the content key encryption unit 207, the output unit 208, and others may be typically realized as an LSI (i.e. an integrated circuit). Each of the functional blocks may be separately realized with an individual chip. Or, they may be realized with individual chips including some parts of the compositional elements constituting each or two or more of the units.

Note that the LSI herein can be referred to as an IC, a system LSI, a super LSI, or an ultra LSI, depending on the degree of integration.

Furthermore, the integration of circuits is not limited to being realized with LSI, but may be realized with a special-purpose circuit or a general-use processor. Alternatively, the integration may be realized with use of an FPGA (field programmable gate array) that is programmable after manufacturing of the LSI, or a re-configurable processor in which connection or setting of circuit cells in the LSI is re-configurable.

Furthermore, if technology for an integrated circuit that replaces LSIs appears due to advances in or derivations from semiconductor technology, that technology may be used for integration of the functional blocks. Bio-technology is one possible application.

Moreover, each of the function blocks may be realized as software running on a computer system or as a combination of an LSI and software. Also, the software may be tamper-resistant.

Description will be made on each compositional element below.

### (1) Content Storage Unit 201

The content storage unit 201 is, in particular, a hard disk, a nonvolatile memory, or the like, and stores therein the content that is to be embedded with the watermark information. In addition, the content may be stored in the content storage unit 20 by an input from the outside, or may be pre-stored in the content storage unit 201.

### (2) Embedding Information Generation Unit 202

The embedding information generation unit 202 serves to generate the watermark information that is to be embedded in the content, and supply the generated watermark information to the digital watermark embedding unit 203. The watermark information is generated, for example, in response to an instruction of a user of the digital watermark embedding apparatus 101. Note that the watermark information generated in the present embodiment is copyright information. Since such copyright information is similar to that in a prior art, detailed description thereof will be omitted.

(3) Digital Watermark Embedding Unit 203

The digital watermark embedding unit 203 serves to divide the audio part of the content stored in the content storage unit 201 into a plurality of blocks, for each of which the digital watermark detection is to be performed, and embed the watermark information generated by the embedding information generation unit 202 in each of the divided blocks.

(4) Content Encryption Unit 204

The content encryption unit 204 serves to encrypts the content embedded with the watermark information, using a content key stored in the content key storage unit 205, as will be later described. In the present embodiment, it is assumed that watermarks are embedded in the audio part. Therefore, more strictly speaking, the content encryption unit 204 serves to encrypt the content comprising the audio part that is embedded with watermarks and the video part that is embedded with no watermarks.

Here, the DES cryptosystem, the AES cryptosystem, or the like is used for encryption of the content. Since these encryption techniques are well known, explanation thereof will be omitted.

(5) Content Key Storage Unit 205

The content key storage unit 205 stores therein a content key, namely key information for encryption of contents. The content key may be stored in the content key storage unit 205 by an input from the outside, or may be pre-stored in the content key storage unit 205.

### (6) Device Key Storage Unit 206

The device key storage unit 206 stores therein a device key, namely the key information used for encrypting the content key. Note that a different device key is allocated to each content playback/editing apparatus (digital watermark detection apparatus) or each group of content playback/editing apparatuses (digital watermark detection apparatuses) in the present embodiment. Naturally, however, a same device key can be allocated to all content playback/editing apparatuses (digital watermark detection apparatuses) in common.

### (7) Content Key Encryption Unit 207

The content key encryption unit 207 encrypts the content key stored in the content key storage unit 206, by means of the device key stored in the device key storage unit 206. Here, the DES cryptosystem, the AES cryptosystem, or the like is used for encryption of the content key. Since these encryption techniques are well known, explanation thereof will be omitted.

### (8) Output Unit 208

The output unit 208 records, on the recording medium 103, the content encrypted by the content encryption unit 204 (referred to below as an encrypted content) and the content key encrypted by the content key encryption unit 207 (referred to below as an encrypted content key). More specifically, the output unit 208 stores the encrypted content in the encrypted content storage area 252 on the recording medium 103, and the encrypted content key in the encrypted content key storage area 251 on the recording medium 103.

### <1.3> Structure of Content Playback/Editing Apparatus (Digital Watermark Detection Apparatus) 102

Next, description will be made on the structure of the content playback/editing apparatus (digital watermark detection apparatus) 102 in details.

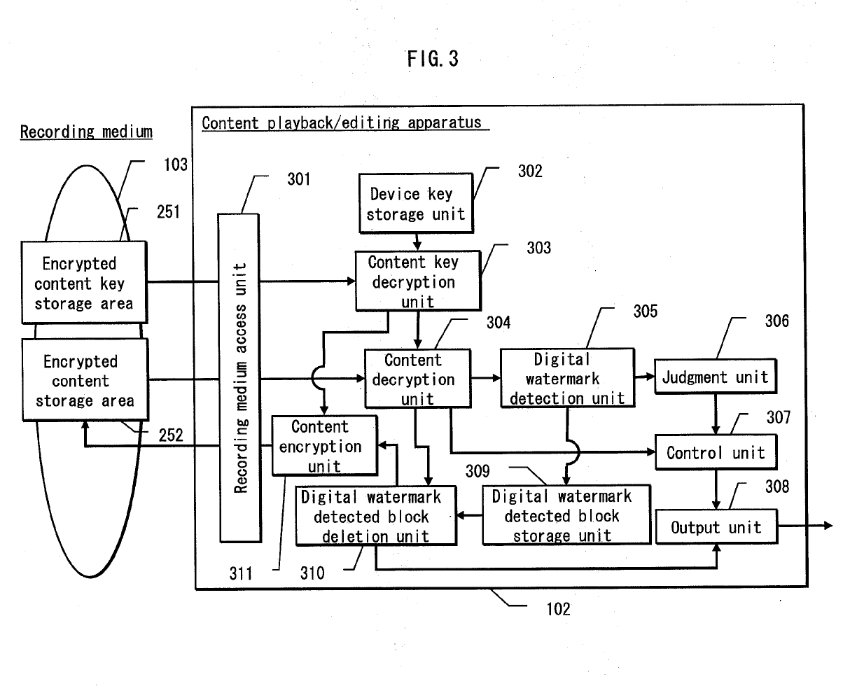

As shown in FIG. 3, the content playback/editing apparatus (digital watermark detection apparatus) 102 includes a recording medium access unit 301, a device key storage unit 302, a content key decryption unit 303, a content decryption unit 304, a digital watermark detection unit 305, a judgment unit 306, a control unit 307, an output unit 308, a digital watermark detected block storage unit 309, a digital watermark detected block deletion unit 310, and a content encryption unit 311. Although not shown, the content playback/editing apparatus (digital watermark detection apparatus) 102 further includes an input unit and the like (e.g. a remote control or a button) that receives an input from the outside, such as a user.

More specifically, the content playback/editing apparatuses (digital watermark detection apparatuses) 102 includes a microprocessor, a RAM, a ROM, a hard disk, and others, all of which are not shown. The RAM, the ROM and the hard disk store a computer program. The content playback/editing apparatus (digital watermark detection apparatuses) 102 fulfils functions thereof due to the microprocessor operating in accordance with the computer program.

In addition, each of the functional blocks, namely the recording medium access unit 301, the device key storage unit 302, the content key decryption unit 303, the content decryption unit 304, the digital watermark detection unit 305, the judgment unit 306, the control unit 307, the output unit 308, the digital watermark detected block storage unit 309, the digital watermark detected block deletion unit 310, and the content encryption unit 311, and others may be typically realized as an LSI (i.e. an integrated circuit). Each of the functional blocks may be separately realized with an individual chip. Or, they may be realized with individual chips including some parts of the compositional elements constituting each or two or more of the units.

Note that the LSI herein can be referred to as an IC, a system LSI, a super LSI, or an ultra LSI, depending on the degree of integration.

Furthermore, the integration of circuits is not limited to being realized with LSI, but may be realized with a special-purpose circuit or a general-use processor. Alternatively, the integration may be realized with use of an FPGA (field programmable gate array) that is programmable after manufacturing of the LSI, or are configurable processor in which connection or setting of circuit cells in the LSI is re-configurable.

Furthermore, if technology for an integrated circuit that replaces LSIs appears due to advances in or derivations from semiconductor technology, that technology may be used for integration of the functional blocks. Bio-technology is one possible application.

Moreover, each of the function blocks may be realized as software running on a computer system or as a combination of an LSI and software. Also, the software may be tamper-resistant.

Description will be made on each compositional element below.

### (1) Recording Medium Access Unit 301

The recording medium access unit 301 serves to read information from the recording medium 103, and write information on the recording medium 103. More specifically, the recording medium access unit 301 reads the encrypted content key and the encrypted content from the encrypted content key storage area 251 and the encrypted content storage area 252 on the recording medium 103 respectively, and writes a re-encrypted content, which will be explained later, in the encrypted content storage area 252.

### (2) Device Key Storage Unit 302

The device key storage unit 302 stores therein a device key, namely the key information used for decryption of the device key. Note that a unique device key is allocated to each content playback/editing apparatus (digital watermark detection apparatus) 102 or each group of content playback/editing apparatuses (digital watermark detection apparatuses) 102 separately. Naturally, however, a same device key can be allocated to all content playback/editing apparatuses (digital watermark detection apparatuses) 102 in common.

### (3) Content Key Decryption Unit 303

The content key decryption unit 303 decrypts the encrypted content key read from the recording medium 103, by means of the device key stored in the device key storage unit 302.

### (4) Content Decryption Unit 304

The content decryption unit 304 decrypts the encrypted content read from the recording medium 103, by means of the content key obtained by the content key decryption unit 303 through decryption.

### (5) Digital Watermark Detection Unit 305

The digital watermark detection unit 305 detects the digital watermarks in the audio part of the content decrypted by the content decryption unit 304, and notifies the information of the detected watermarks to the judgment unit 306 which will be described a bit later. To be more precise, the digital watermark detection unit 305 divides the audio part of the content into a plurality of blocks, for each of which digital watermark detection is to be performed, and detects a watermark information piece in each of the blocks. If the watermark information is detected, the digital watermark detection unit 305 notifies the type of the detected watermark information to the later-described judgment unit 306.

When a plurality of watermark information pieces are detected, the digital watermark detection unit 305 notifies, for each of all the detected watermark information pieces, the type of the detected watermark information and the block in which the watermark information was detected, to the digital watermark detected block storage unit 309 which will be described later.

### (6) Judgment Unit 306

The judgment unit 306 judges whether the playback of the content is permitted, based on the watermark information detected by the digital watermark detection unit 305. The detailed description of the structure of the judgment unit 306 and the processing performed by the judgment unit 306 will be made in <1.4>.

### (7) Control Unit 307

The control unit 307 controls the playback of the content, based on a judgment result of the judgment unit 306. Description will also be made more in details for the control performed by the control unit 307, together with the detailed description of the judgment unit 306.

### (8) Output Unit 308

Upon being controlled by the control unit 307, the output unit 308 outputs the content to a display device, such as a monitor display. More specifically, when the control unit 307 controls the output unit 308 to “play back the content”, the output unit 308 receives the content to be played back, and outputs the received content to a display device, such as a monitor display. On the other hand, when the control unit 307 controls the output unit 308 to interrupt playback, the output unit 308 performs the interrupt processing of the playback (e.g. displaying a warning, or stopping the content playback) in accordance with the instruction of the control unit 307.

Meanwhile, if the content to be played back is an edited content received from the digital watermark detected block deletion unit 310, the output unit 308 may output the content to a display device without condition.

### (9) Digital Watermark Detected Block Storage Unit 309

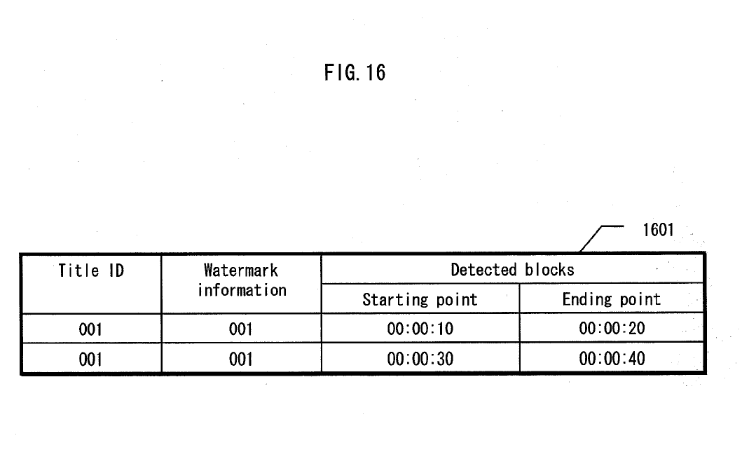

The digital watermark detected block storage unit 309 stores therein the information that specifies the blocks of the content in which the digital watermark detection unit 305 has detected the digital watermark. FIG. 16 shows an example of the information stored in the digital watermark detected block storage unit 309.

In the FIG. 16 example, the digital watermark detected block storage unit 309 stores therein, for each digital watermark information piece, a title ID, a watermark type, and a detected block. The title ID herein is the information that allows identifying the content in which the watermark information has been detected, within the recording medium 103. The watermark type is the information that indicates the type of the detected watermark information. The detected block is the information that allows specifying the block of the content embedded with the watermark information. In the present embodiment, each of the blocks embedded with the watermark information is identified by starting and ending points thereof, which are expressed in a time length that has been elapsed since the playback of the content from the beginning started.

Note that the content in which the watermark information has been detected is not limited to being identified by the title ID. Any kind of information, including a file name of the content data, may be used, as long as the information allows identifying the content in which the watermark information has been detected.

Further, each of the blocks of the content embedded with the watermark information is not limited to being identified by the time length that has been elapsed since the playback of the content from the beginning started. When the content is the data in MPEG-2 TS format, for example, the detected block may be identified by a PTS (Presentation Time Stamp), an SPN (Source Packet Number), or the like. It is also possible to put an identifying number on each block, and express each block in the identifying number. This is to say that any kind of information may be used, as long as the information allows identifying each of the blocks of the content embedded with the watermark information.

The digital watermark detected block storage unit 309 stores therein the information about the watermarks notified from the digital watermark detection unit 305. This means that the digital watermark detected block storage unit 309 is able to store only the watermark information with respect to the blocks for which decryption and watermark information detection has been already performed. Accordingly, in the description below, it is assumed that, when the processing using the information stored in the digital watermark detected block storage unit 309 is performed, the processing is performed for the blocks whose watermark information has been notified at least once (more specifically, the blocks whose playback has been performed once in the past).

### (10) Digital Watermark Detected Block Deletion Unit 310

The digital watermark detected block deletion unit 310 generates an edited content, that is, the data obtained by deleting the blocks embedded with the watermark information from the content data in accordance with the information held in the digital watermark detected block storage unit 309. The generated edited content is written on the recording medium via the content encryption unit 311, or output to a display device, such as a monitor display, via the output unit 308. The detailed description on the processing performed by the digital watermark detected block deletion unit 310 will be made in <1.8>.

### (11) Content Encryption Unit 311

The content encryption unit 311 encrypts the edited content generated by the digital watermark detected block deletion unit 310 by means of the content key acquired by the decryption of the content key decryption unit 303, to generate a re-encrypted content. Here, the generated re-encrypted content is to be stored in the encrypted content key storage area 251 in the recording medium 103.

### <1.4> Structures of Judgment Unit 306 and Control Unit 307

Next, description will be made on the structures of the judgment unit 306 and the control unit 307 in details.

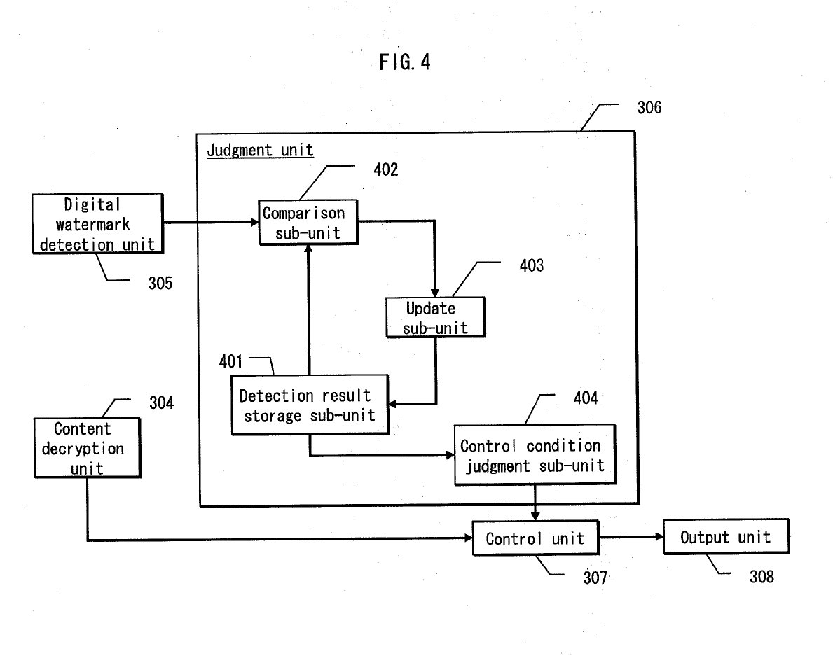

As shown in FIG. 4, the judgment unit 306 includes a detection result storage sub-unit 401, a comparison sub-unit 402, an update sub-unit 403, and a control condition judgment The structures of these compositional elements will be looked at below.

### (1) Detection Result Storage Sub-Unit 401

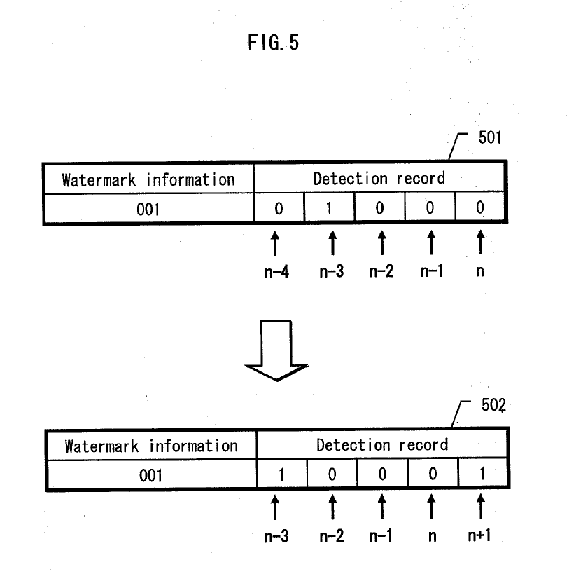

The detection result storage sub-unit 401 stores therein the watermark information and the record thereof, the watermark information having been detected by the digital watermark detection unit 305. FIG. 5 shows an example.

FIG. 5 shows the detection record of the watermark information “001”. The detection record herein is the information indicating whether the watermark information for which the detection is performed (e.g. the watermark information “001” in FIG. 5) has been detected in each block in the past. In an example of the upper block of FIG. 5, it is shown whether the watermark information “001” has been detected, with respect to the blocks lying between an Nth block, which is the block in which the watermark detection processing was most recently performed by the digital watermark detection unit 305, and an (N−4)th block, which is the block in which the processing was performed four blocks before the Nth block. In the FIG. 5 example, “0” means undetected, and “1” means detected. From the above state, if the processing is further performed on a block next to the Nth block, the detection record information of each block is shifted one place to the left, and it is recorded in the last place on the right whether the watermark information “001” has been detected in the (N+1)th block, as shown in the lower block of FIG. 5. From then on, as the processing proceeds, the detection record is updated in a similar manner.

Note that, the detection result storage sub-unit 401 stores therein the detection record of the watermark information of only one type in the present embodiment, even when several types of watermark information is detected. The type of the watermark information to be stored is determined by an update condition that will be described below.

### (2) Comparison Sub-Unit 402

The comparison sub-unit 402 serves to compare the watermark information detected by the digital watermark detection unit 305 with the watermark information stored in the detection result storage sub-unit 401, and determine an update method of the detection record stored in the detection result storage sub-unit 401 while checking the comparison result against a prescribed update condition. The followings are the examples of the update condition, and the examples of the method for updating the detection record according to each update condition.

(a) In the Case where the Update Condition is “Always Hold the Newest Watermark Information”

In this case, when different watermark information from that stored in the detection result storage sub-unit 401 has been detected by the digital watermark detection unit 305, the comparison sub-unit 402 switches the watermark information to be stored in the detection result storage sub-unit 401 to the newly detected watermark information. More specifically, the comparison sub-unit 402 instructs the update sub-unit 403 to update the watermark information stored in the detection result storage sub-unit 401, and to reset the detection record (in the FIG. 5 example, all the data contained in the detection record is set to zero).

On the other hand, when the same watermark information as that stored in the detection result storage sub-unit 401 has been detected by the digital watermark detection unit 305, the comparison sub-unit 402 instructs the update sub-unit 403 to update the detection record stored in the detection result storage sub-unit 401, by adding thereto the information indicating that the watermark information has been detected (in the FIG. 5 example, each data contained in the detection record is shifted one place to the left, and the data “1” is recorded in the last place on the right).

Or, when no watermark information has been detected by the digital watermark detection unit 305, the comparison sub-unit 402 instructs the update sub-unit 403 to update the detection record stored in the detection result storage sub-unit 401, by adding thereto the information indicating that no watermark information has been detected (in the FIG. 5 example, each data contained in the detection record is shifted one place to the left, and the data “0” is recorded in the last place on the right).

(b) In the Case where the Update Condition is “Hold the Watermark Information Having a High Priority”

In this case, when different watermark information from that stored in the detection result storage sub-unit 401 has been detected by the digital watermark detection unit 305, the comparison sub-unit 402 compares the priority of the watermark information detected by the digital watermark detection unit 305 with the priority of the watermark information stored in the detection result storage sub-unit 401.

If the watermark information received from the digital watermark detection unit 305 has a higher priority, the comparison sub-unit 402 instructs the update sub-unit 403 to update the watermark information stored in the detection result storage sub-unit 401, and to reset the detection record (in the FIG. 5 example, all the data contained in the detection record is set to zero).

On the other hand, if the watermark information received from the digital watermark detection unit 305 has a lower priority, the comparison sub-unit 402 instructs the update sub-unit 403 to update the detection record stored in the detection result storage sub-unit 401, by adding thereto the information indicating that the watermark information has been detected (in the FIG. 5 example, each data contained in the detection record is shifted one place to the left, and the data “1” is recorded in the last place on the right).

Or, when no watermark information has been detected by the digital watermark detect ion unit 305, the comparison sub-unit 402 instructs the update sub-unit 403 to update the detection record stored in the detection result storage sub-unit 401, by adding thereto the information indicating that no watermark information has been detected (in the FIG. 5 example, each data contained in the detection record is shifted one place to the left, and the data “0” is recorded in the last place on the right).

In addition, although not shown in FIG. 13, the “priority” means that a predetermined priority is assigned to each watermark information type. The information about each priority assigned to each watermark information type may be stored in advance in the content playback/editing apparatus (digital watermark detection apparatus) 102 as a correspondence table of the watermark information type and the priority, for example. Alternatively, each priority may be embedded in each watermark information piece as a part thereof (e.g. the greater the number indicating the type, the higher the priority).

Further, the priority is not fixed, and may be modified dynamically. For example, it is envisaged that the greater the number of times in which an identical type of the watermark information has been detected, the higher the priority of that type of the watermark information becomes. Moreover, it is also envisaged, when no watermark information has been detected, that nothing is performed, and of course the data “0” is not added. This is suitable for a case that the playback control condition is “when the total number of the blocks in which the watermark information has been detected exceeds a predetermined threshold value” as will be described below.

### (3) Update Sub-Unit 403

The update sub-unit 403 serves to update either the watermark information or the detection record thereof, or both of them, stored in the detection result storage sub-unit 401, in accordance with the comparison result and the instruction of the comparison sub-unit 402. The update method has been explained in details in the description of the comparison sub-unit 402.

### (4) Control Condition Judgment Sub-Unit 404

The control condition judgment sub-unit 404 serves to check the detection record stored in the detection result storage sub-unit 401 against the prescribed playback control condition, and judge whether the content is obtained by illegal acts, such as unauthorized copying.

More specifically, the control condition judgment sub-unit 404 refers to the watermark information and the detection record stored in the detection result storage sub-unit 401 with respect to each block, that is, a unit for detection, and when the referred detection record satisfies the control condition, judges that the content is obtained by illegal acts, such as unauthorized copying.

There are a lot of examples of the playback control condition. In particular, some of the examples are “when the watermark information pieces have been detected in at least two blocks in the past five blocks” as mentioned above, “when the total number of the blocks in which the watermark information has been detected exceeds a predetermined threshold value”, “when the watermark information has been detected at least once”, “when the watermark information has been detected for several times in succession”, and “when the watermark information has been detected at a predetermined interval”. Naturally, the playback control condition is not limited to these examples, and some other conditions may be set depending on the intent of the copyright holder of the content.

### (5) Control Unit 307

The control unit 307 serves to control the playback of the content, in accordance with the judgment result made by the control condition judgment sub-unit 404 of the judgment unit 306 as to whether the playback control condition is satisfied (i.e. whether the content is obtained by unauthorized copying and such).

More specifically, when the control condition judgment sub-unit 404 has judged that the content is not obtained by illegal acts, such as unauthorized copying, the control unit 307 controls the output unit 308 to continue to play back the content without a notable interruption. On the other hand, when the control condition judgment sub-unit 404 has judged that the content is obtained by illegal acts, such as unauthorized copying, the control unit 307 controls the output unit 308 to execute the operations (e.g. a playback interruption) corresponding to the watermark information.

Now, description will be made on the operations of the digital watermark embedding/detection system.

### <1.5> Operations of The Content Data Generation Apparatus (Digital Watermark Embedding Apparatus) 101

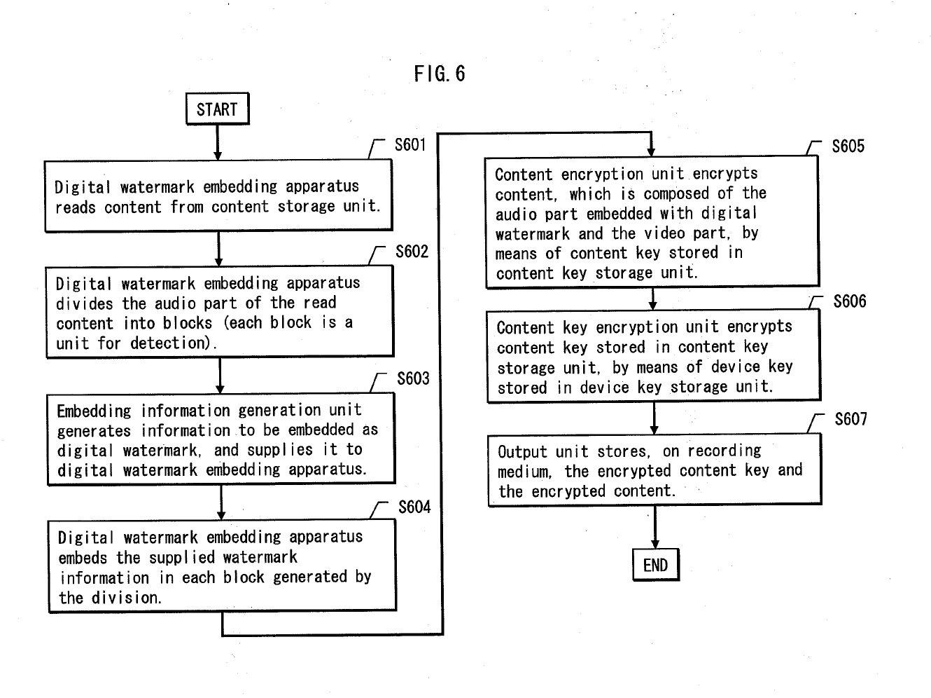

Firstly, the operations of the content data generation apparatus (digital watermark embedding apparatus) 101 will be described, with reference to FIG. 6.

Upon receiving an instruction so as to embed the watermark information via an input unit which is not shown, the digital watermark embedding unit 203 reads the content from the content storage unit 201 (Step S601).

Subsequently, the digital watermark embedding unit 203 divides the audio part of the read content into a plurality of blocks, for each of which digital watermark detection is to be performed (Step S602). In the meantime, the embedding information generation unit 202 generates the watermark information to be embedded as the digital watermark in accordance with the instructions of a user, and supplies the generated watermark information to the digital watermark embedding unit 203 (Step S603). The digital watermark embedding unit 203 embeds each of the supplied watermark information pieces in each of the blocks generated as a result of the division (Step S604).

The content encryption unit 204 encrypts the content composed of the audio part in which the digital watermark has been embedded, and the video part in which no digital watermark has been embedded, by means of the content key stored in the content key storage unit 205, to generate an encrypted content (Step S605). The content key encryption unit 207 also encrypts the content key stored in the content key storage unit 205, by means of the device key stored in the device key storage unit 206, to generate an encrypted content key (Step S606).

The output unit 208 stores the encrypted content key generated by the content key encryption unit 207 in the encrypted content key storage area of the recording medium 103. The output unit 208 also stores the encrypted content generated by the content encryption unit 204 in the encrypted content storage area of the recording medium 103 (Step S607).

### <1.6> Playback Operations of the Content Playback/Editing Apparatus (Digital Watermark Detection Apparatus) 102

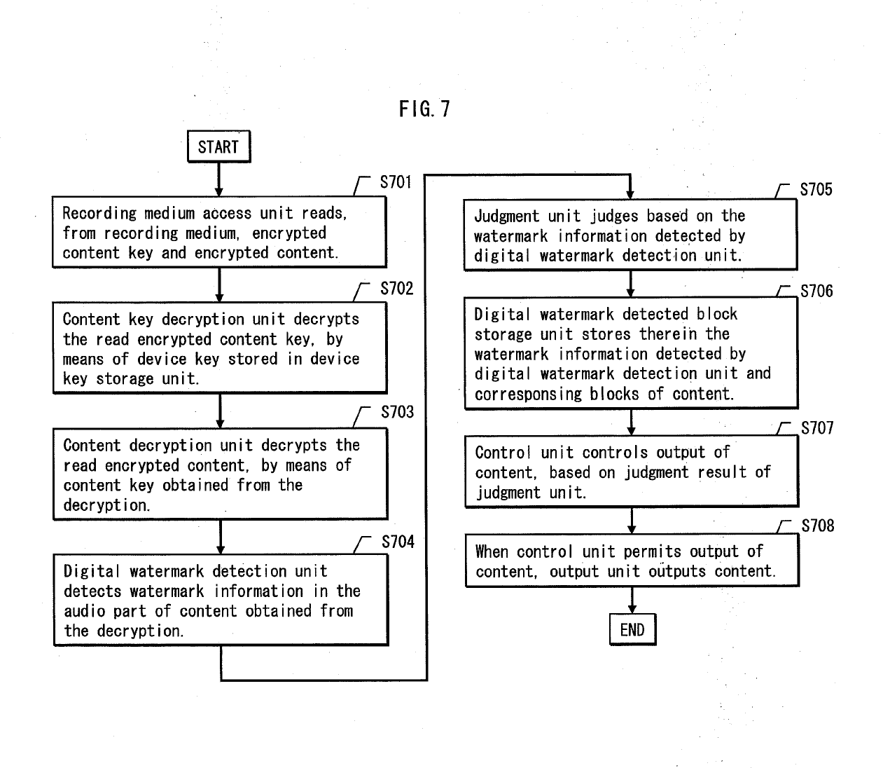

Next, description will be made on the playback operations of the content playback/editing apparatus (digital watermark detection apparatus) 102, with reference to FIG. 7.

When the content playback/editing apparatus (digital watermark detection apparatus) 102 receives the instruction of a user so as to play back the content via an input unit which is not shown, the recording medium access unit 301 reads the encrypted content key and the encrypted content from the recording medium 103 (Step S701). Subsequently, the content key decryption unit 303 decrypts the read decrypted content key, by means of the device key stored in the device key storage unit 302 (Step S702). The content decryption unit 304 also decrypts the read decrypted content, by means of the content key obtained by the decryption in Step S702 (Step S703).

The digital watermark detection unit 305 detects the watermark information from the audio part of the content obtained by the decryption in Step S703 (Step S704). Based on the watermark information detected by the digital watermark detection unit 305, the judgment unit 306 judges whether the content to be played back is obtained by illegal acts, such as unauthorized copying (Step S705).

The digital watermark detected block storage unit 309 stores therein the watermark information detected by the digital watermark detection unit 305, the title ID that specifies the content data for which the detection has been performed, and the information that specifies the blocks of the content in which the watermark information has been detected (Step S706).

The control unit 307 controls content output, in accordance with a judgment result of the judgment unit 306 (Step S707). More specifically, when the content is not judged to be an unauthorized copy and the like, the control unit 307 permits the playback of the content, and when the content is judged to be an unauthorized copy and the like, the control unit 307 controls to interrupt the playback of the content according to the watermark information type.

When the control unit 307 permits playback, the output unit 308 outputs the content to a display device, such as a monitor display, and when the control unit 307 performs other playback control, the output unit 308 interrupts playback according to the control (Step S708).

The operations of the judgment unit 306 will be described in <1.7>.

### <1.7> Operations of the Judgment Unit 306

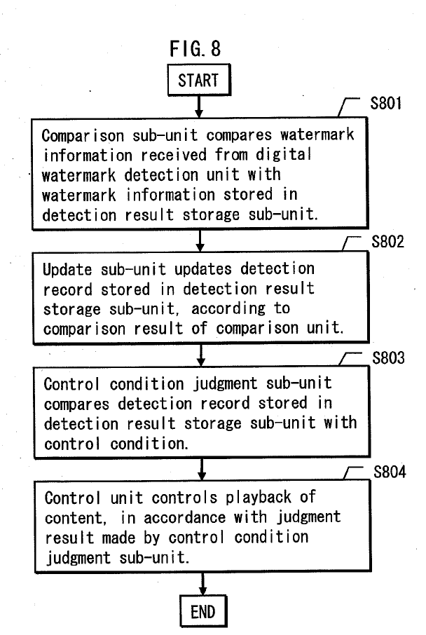

The detailed description will be made on the operations of the judgment unit 306, with reference to FIG. 8.

The comparison sub-unit 402 compares the watermark information received from the digital watermark detection unit 305 with the watermark information detection record stored in the detection result storage sub-unit 401, and confirms whether the update condition is satisfied (Step S801). Subsequently, in accordance with a confirmation result of the comparison sub-unit 402 as to whether the update condition is satisfied, the update unit 403 updates the detection result stored in the detection result storage sub-unit 401 (Step S802).

The control condition judgment sub-unit 404 judges whether the watermark information detection record stored in the detection result storage sub-unit 401 satisfies the playback control condition (Step S803). Further, in accordance with a judgment result of the control condition judgment sub-unit 404 as to whether the playback control condition is satisfied, the control unit 307 controls the playback of the content (Step S804).

Meanwhile, although in the present embodiment the update of the detection record according to Steps S801 and 5802 is performed prior to the judgment based on the playback control condition in Step S803, the order of these steps may be reversed.

### <1.8> Editing Operations of the Content Playback/Editing Apparatus (Digital Watermark Detection Apparatus) 102

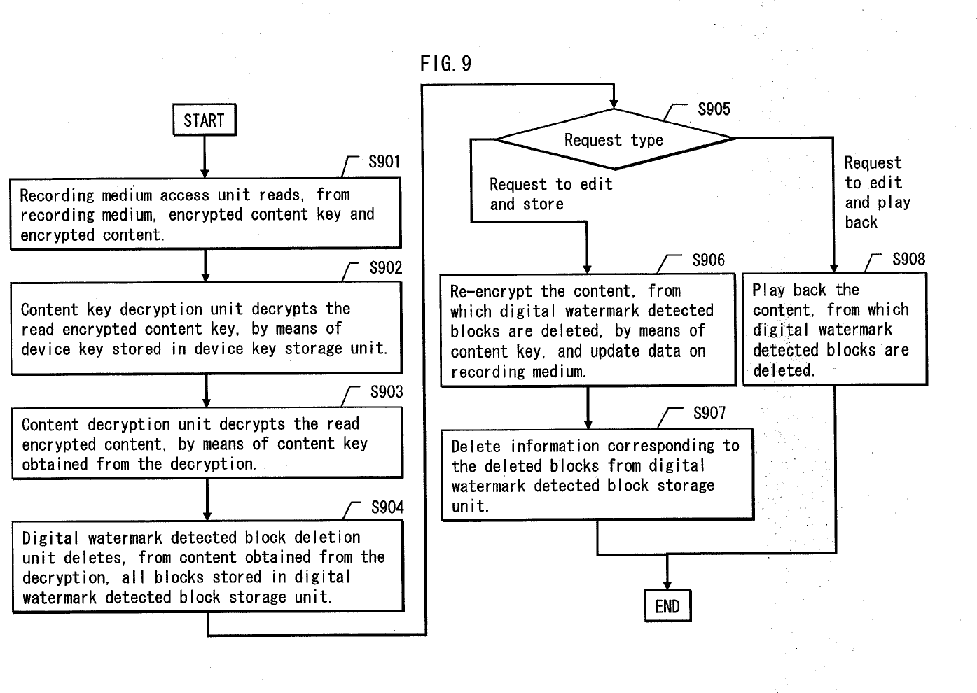

Description will be made on the editing operations of the content playback/editing apparatus (digital watermark detection apparatus) 102, with reference to FIG. 9.

The editing operations are executed when the content playback/editing apparatus (digital watermark detection apparatus) 102 receives, from the user, a request to edit.

The request to edit in present embodiment is either a request to edit and store, which is for writing the edited content on the recording medium 103, and a request to edit and play back, which is for playing back the edited content.

When the content playback/editing apparatus (digital watermark detection apparatus) 102 receives the request to edit, firstly, the recording medium access unit 301 reads the encrypted content key and the encrypted content from the recording medium 103 (Step S901).

And then, the content key decryption unit 303 decrypts the read encrypted content key, by means of the device key stored in the device key storage unit 302 (Step S902). Subsequently, the content decryption unit 304 decrypts the read encrypted content, by means of the content key (Step S903).

The digital watermark detected block deletion unit 310 deletes, from the content obtained through the decryption, all the blocks stored in the digital watermark detected block storage unit 309 (Step S904).

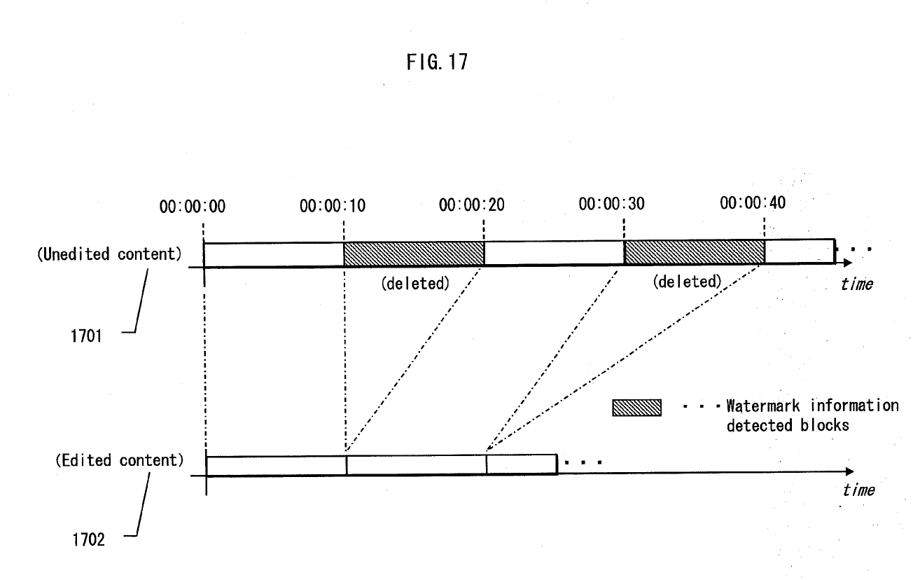

Now, in conjunction with the examples shown in FIG. 16 and FIG. 17, description will be made more in details on the processing of Step S904, that is to say, deleting the blocks in which the watermark information has been detected.

FIG. 16 shows the watermark information detected blocks stored in the digital watermark detected block storage unit 309. In FIG. 16, it is shown that the watermark information “001” has been detected in two blocks in the title ID titled as “001”.

FIG. 17 shows the state shown in FIG. 16 diagrammatically. In FIG. 17, it is shown that, in an unedited content 1701, two blocks exist in which the watermark information has been detected. In Step S906, the watermark information detected blocks are deleted, and previous and next blocks to each of the deleted blocks are combined respectively, so as to generate the edited content.

The content generated by the above editing operations has no blocks in which the watermark information is to be detected. Therefore, in playing back the edited content, playback control by the control unit 307, such as stopping the audio output and displaying a warning message, is not performed, thereby enabling users to view the content as usual.

As a result, even if a children's birthday party with a movie content (such as an animation movie) audible in the background is recorded on a camcorder, and the audio embedded with copyright information has been inadvertently record thereon, the recorded data can viewed without the influence of playback control, such as displaying a warning and stopping the audio output.

Meanwhile, in the case where an unauthorized copy of the whole content is intentionally made by setting a camcorder in front of the display to record the content, it is generally anticipated that a number of blocks in which the watermark information is to be detected exists in the copy. In such a case, the most part of the content obtained from the copy is to be deleted through the editing operations.

Consequently, the content that is left after the editing operations has no substantial value. Accordingly, the editing operations as proposed in the present embodiment do not promote unauthorized copying practically.

Those operations performed after deleting the blocks in which the watermark information has been detected depends on whether the received request is either the request to edit and store, or the request to edit and play back.

When the received request is the request to edit and store (“Request to edit and store” in Step S905), the content, from which the information stored in the digital watermark detected block storage unit 309 has been deleted (i.e. the edited content in the above), is output to the content encryption unit 311.

The content encryption unit 311 encrypts the edited content by means of the content key to generate a re-encrypted content. Further, the content encryption unit 311 outputs the generated re-encrypted content to the recording medium 103, via the recording medium access unit (Step S906).

Meanwhile, although in the present embodiment the encrypted edited content is overwritten in the encrypted content storage area 252 that previously stored therein the unedited content, the content may be written in some other area or another recording medium.

Further, the digital watermark detected block deletion unit 310 deletes the information stored in the digital watermark detected block storage unit 309 (Step S907). This is to prevent a possible confusion during processing, due to the already-deleted blocks being referred to at the time of the playback of the edited content.

On the other hand, when the received request is the request to edit and play back, the edited content is sent to the output unit 308 (Step S908). The output unit 308 displays the edited content to a display device, such as a monitor display, to play back the content.

We have looked at the operations of the digital watermark embedding/detection system so far.

Meanwhile, although in the above-described first embodiment the digital watermark detected block deletion unit 310 deletes all the blocks corresponding to the digital watermark detected blocks as stored in the digital watermark detected block storage unit 309, the present invention is not limited to this.

For example, it is possible to select minimum blocks within the range that does not trigger playback interruption control, and delete the selected blocks, by causing the control unit 307 to refer to the playback control condition.

Even specifically, in the case where the play back control operations are performed for the content shown in FIG. 14 if the watermark information has been detected in more than two blocks in five as mentioned above, it is not necessary to delete the two blocks corresponding to a period between time A and time B, and a period between time C and time D respectively. It is only necessary to delete one of the two blocks, in order to circumvent the playback control.

In this case, put it simply, if one of the two blocks is deleted, the edited content does not fall under the condition that “the watermark information has been detected in more than two blocks in five”. As a result, the digital watermark detected block deletion unit 310 only deletes the block corresponding to the period between time A and time B, selectively. It can be determined automatically, for example, or selected upon receiving the input of a user, which block is to be deleted.

In addition, when the selection for the deletion is made upon receiving the input of a user, it is also possible to display, for the purpose of facilitating the selection of the user, a preview window showing each data stored in each of the blocks listed as candidate targets for the deletion. Thus, by not deleting all the blocks stored in the digital watermark detected block storage unit 309, but by selecting one or more blocks according to a predetermined rule regarding the playback control by the control unit 307, an advantageous effect can be achieved that the deleted blocks are minimized.

Further, although in Step S906 the digital watermark detected block deletion unit 310 deletes both the audio and video parts located in the blocks corresponding to the watermark information detected blocks stored in the digital watermark detected block storage unit 309, the present invention is not limited to this.

Since the watermark information is embedded only in the audio data in the present embodiment, it is possible to delete only the audio data in the blocks corresponding to the watermark information detected blocks stored in the digital watermark detected block storage unit 309. Moreover, the audio data does not need to be deleted, and the audio data in the blocks corresponding to the watermark information detected blocks may be replaced with other audio data containing no watermark information.

This allows retaining the video data in the edited content, and to circumvent playback control, such as a warning display, thereby enabling users to view the content as usual except that the audio is not output.

### Second Embodiment

Next, description will be made on another embodiment of the present invention. The basic structure of the second embodiment is similar to the first embodiment. However, the second embodiment differs in the method for updating the detection record of the watermark information. Further, in the second embodiment, the editing operations, such as deleting the blocks in which the watermark information has been detected as in the first embodiment, are not performed. Instead, the playback operation of skipping the blocks (referred to as a special playback) is performed in the second embodiment.

In the second embodiment, when several types of watermark information pieces have been detected, all the detected watermark information types are stored, and control (judgment) is performed, for each of the stored watermark information types, as to whether playback control operations, such as a playback interruption, is to be executed. Also, according to the judgment result, when it is anticipated that the playback interruption is to occur, the special playback is performed so that the content can be viewed as usual. The detailed description thereof will be made in <2.2>.

Meanwhile, since the structure of the digital watermark embedding/detection system, the operations of the content data generation apparatus (digital watermark embedding apparatus), and the playback operations of the content playback/editing apparatus (digital watermark detection apparatus) in the second embodiment are similar to those in the first embodiment, explanation thereof will be omitted.

Further, since the similar processing to the first embodiment, such as the processing corresponding to storing the re-encrypted content and playing back the edited content in the first embodiment, except for the processing of generating the edited content, is performed in the second embodiment, explanation thereof will be omitted.

### <2.1> Structure of Content Playback/Editing Apparatus (Digital Watermark Detection Apparatus) 102

Description will be made on the structure of the content playback/editing apparatus (digital watermark detection apparatus) 102 according to the second embodiment.

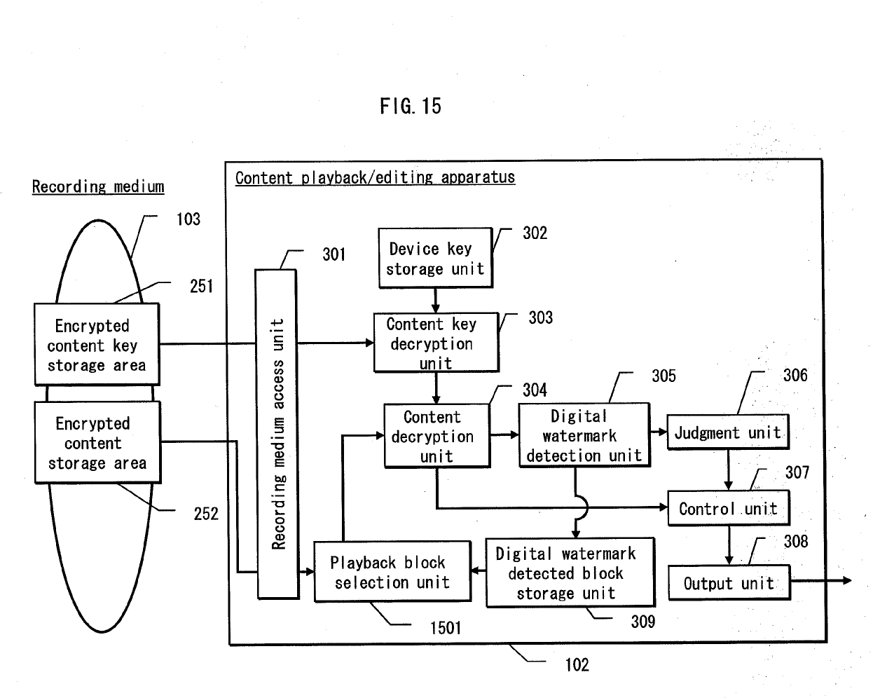

As shown in FIG. 15, the content playback/editing apparatus (digital watermark detection apparatus) 102 includes a recording medium access unit 301, a device key storage unit 302, a content key decryption unit 303, a content decryption unit 304, a digital watermark detection unit 305, a judgment unit 306, a control unit 307, an output unit 308, a playback block selection unit 1501. Although not shown, the content playback/editing apparatus (digital watermark detection apparatus) 102 according to the second embodiment further includes an input unit and the like (e.g. a remote control or a button) that receives an input from the outside, such as a user.

The content playback/editing apparatus (digital watermark detection apparatus) 102 includes a microprocessor, a RAM, a ROM, a hard disk, and others, all of which are not shown. The RAM, the ROM and the hard disk store there in a computer program. The content playback/editing apparatus (digital watermark detection apparatus) 102 fulfils functions thereof due to the microprocessor operating in accordance with the computer program.

In addition, each of the functional blocks, namely the recording medium access unit 301, the device key storage unit 302, the content key decryption unit 303, the content decryption unit 304, the digital watermark detection unit 305, the judgment unit 306, the control unit 307, the output unit 308, and the playback block selection unit 1501, and others may be typically realized as an LSI (i.e. an integrated circuit). Each of the functional blocks may be separately realized with an individual chip. Or, they may be realized with individual chips including some parts of the compositional elements constituting each or two or more of the units.

Note that the LSI herein can be referred to as an IC, a system LSI, a super LSI, or an ultra LSI, depending on the degree of integration.

Furthermore, the integration of circuits is not limited to being realized with LSI, but may be realized with a special-purpose circuit or a general-use processor. Alternatively, the integration may be realized with use of an FPGA (field programmable gate array) that is programmable after manufacturing of the LSI, or a re-configurable processor in which connection or setting of circuit cells in the LSI is re-configurable.

Furthermore, if technology for an integrated circuit that replaces LSIs appears due to advances in or derivations from semiconductor technology, that technology may be used for integration of the functional blocks. Bio-technology is one possible application.

Moreover, each of the function blocks may be realized as software running on a computer system or as a combination of an LSI and software. Also, the software may be tamper-resistant.

Description will be made on each the compositional elements below.

### (1) Recording Medium Access Unit 301

The recording medium access unit 301 serves to read information from the recording medium 103. More specifically, the recording medium access unit 301 reads the encrypted content key and the encrypted content from the encrypted content key storage area 251 and the encrypted content storage area 252 of the recording medium 103, respectively.

### (2) Device Key Storage Unit 302

The device key storage unit 302 stores therein a device key, namely the key information used for decryption of the encrypted content key. Note that, in the present embodiment as well, a unique device key is allocated to each content playback/editing apparatus (digital watermark detection apparatus) 102 or each group of content playback/editing apparatuses (digital watermark detection apparatuses) 102, as similarly to the first embodiment. However, like in the first embodiment, a same device key can be allocated to all content playback/editing apparatuses (digital watermark detection apparatuses) 102 in common.

### (3) Content Key Decryption Unit 303

The content key decryption unit 303 decrypts the encrypted content key read from the recording medium 103, by means of the device key stored in the device key storage unit 302.

### (4) Content Decryption Unit 304

The content decryption unit 304 decrypts the encrypted content read from the recording medium 103, by means of the content key obtained by the content key decryption unit 303 through decryption.

### (5) Digital Watermark Detection Unit 305

The digital watermark detection unit 305 detects the digital watermarks in the audio part of the content decrypted by the content decryption unit 304, and notifies the information of the detected watermarks to the judgment unit 306 which will be described a bit later.

To be more precise, the digital watermark detection unit 305 divides the audio part of the content into a plurality of blocks, for each of which digital watermark detection is to be performed, and detects a watermark information piece in each of the blocks. If the watermark information is detected, the digital watermark detection unit 305 notifies the type of the detected watermark information to the later-described judgment unit 306.

Further, when a plurality of watermark information pieces are detected, the digital watermark detection unit 305 notifies, for each of all the detected watermark information pieces, the type of the detected watermark information and the block in which the watermark information was detected, to the detected block storage unit 309 which will be described later.

### (6) Judgment Unit 306

The judgment unit 306 judges whether the playback of the content is permitted based on the watermark information detected by the digital watermark detection unit 305. The detailed description of the processing performed by the judgment unit 306 will be made in <2.2>.

### (7) Control Unit 307

The control unit 307 controls the playback of the content based on a judgment result of the judgment unit 306. Description will also be made more in details for the control performed by the control unit 307, together with the detailed description of the judgment unit 306.

### (8) Output Unit 308

Upon being controlled by the control unit 307, the output unit 308 outputs the content to a display device, such as a monitor display. More specifically, when the control unit 307 controls the output unit 308 to “play back the content”, the output unit 308 receives the content to be played back, and outputs the received content to a display device, such as a monitor display.

On the other hand, when the control unit 307 controls the output unit 308 to interrupt playback, the output unit 308 performs the interrupt processing of the playback (e.g. displaying a warning, or stopping the content playback) in accordance with the instruction of the control unit 307.

### (9) Digital Watermark Detected Block Storage Unit 309

The digital watermark detected block storage unit 309 stores therein the information that specifies the blocks of the content in which the digital watermark detection unit 305 has detected the digital watermark.

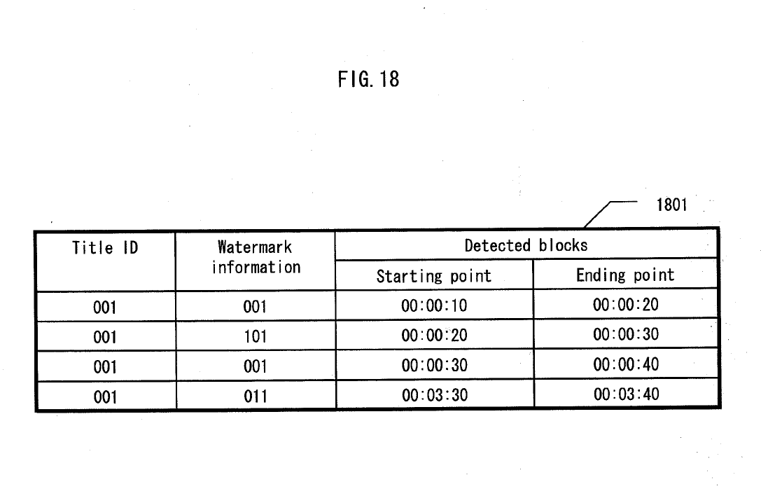

FIG. 18 shows an example of the information stored in the digital watermark detected block storage unit 309.

In the FIG. 18 example, the digital watermark detected block storage unit 309 stores therein, for each digital watermark information piece, a title ID, a watermark type, and a detected block. The title ID herein is the information that allows identifying the content in which the watermark information has been detected, within the recording medium 103. The watermark type is the information that indicates the type of the detected watermark information. The detected block is the information that allows specifying the block of the content embedded with the watermark information.

In the present embodiment, the block embedded with the watermark information is identified by a starting and ending points of the block, which are expressed in a time length that has been elapsed since the playback of the content from the beginning started. Again, like the first embodiment, the information stored in the digital watermark detected block storage unit 309 is not limited to the example shown in FIG. 18.

### (10) Playback Block Selection Unit 1501

The playback block selection unit 1501 serves to select the blocks of the content that are to be played back, in accordance with the information stored in the digital watermark detected block storage unit 309, so as to avoid that the blocks embedded with the watermark information are played back. The selected blocks are sent to the content decryption unit 304. Description will be made more in details for the operations of the playback block selection unit 1501 in <2.4>.

### <2.2> Structures of the Judgment Unit 306 and the Control Unit 307

Next, description will be made in detail on the structures of the judgment unit 306 and the control unit 307.

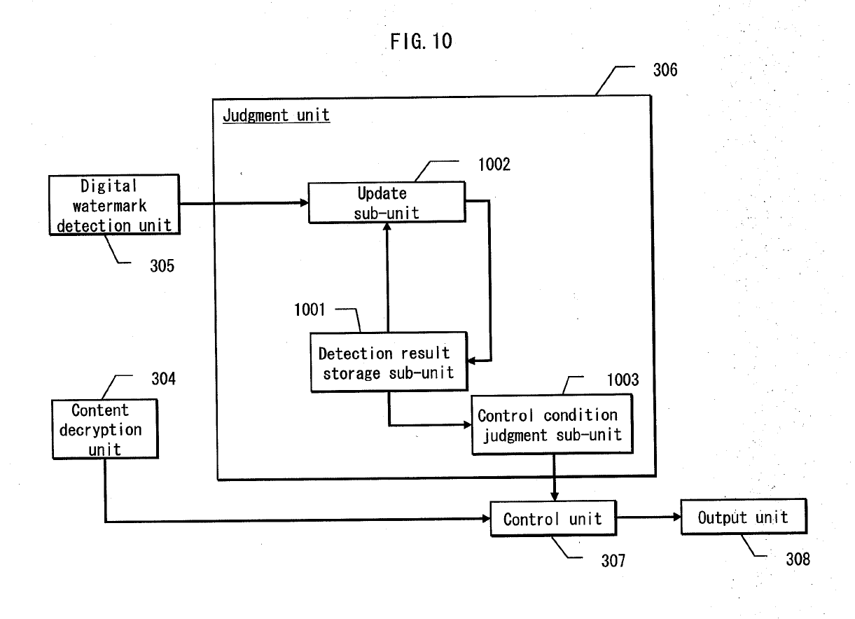

As shown in FIG. 10, the judgment unit 306 includes a detection result storage sub-unit 1001, an update sub-unit 1002, and a control condition judgment sub-unit 1003.

### (1) Detection Result Storage Sub-Unit 1001

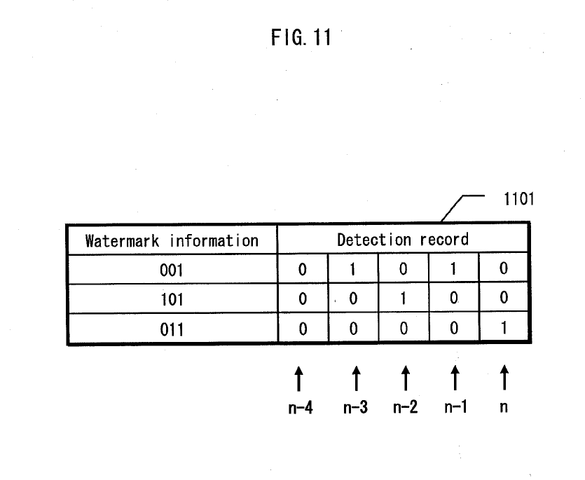

The detection result storage sub-unit 1001 stores therein the watermark information detected by the content playback/editing apparatus (digital watermark detection apparatus) 102, and the detection record thereof. FIG. 11 shows an example.

FIG. 11 shows an example in which the watermark information “001”, “101”, and “011” have been detected. The detection record shows, starting from the left, whether the watermark information “001”, “101”, and “011” has been detected in any of an (N−4)th block, an (N−3)th block, an (N−2)th block, an (N−1)th block, and an Nth block. Here, like the first embodiment, the Nth block is the newest block in which watermark detection processing is performed by the digital watermark detection unit 305.

Further, like the first embodiment, “0” means undetected, and “1” means detected in the FIG. 11 as well. This is to say that the FIG. 11 example shows that no watermark information has been detected in the (N−4)th block. The FIG. 11 example also shows that the watermark information “001” has been detected in the (N−3)th block and the (N−1)th block, “101” has been detected in the (N−2)th block, and “011” has been detected in the Nth block. In addition, in the explanation of the update sub-unit 1002 below, description will be made on the detection record update method in the case where the watermark information has been (or has not been) detected in the (N+1)th block.

### (2) Update Sub-Unit 1002

The update sub-unit 1002 serves to determine whether the detection result stored in the detection result storage sub-unit 1001 needs to be updated, by comparing the watermark information detected by the digital watermark detection unit 305 with the watermark information stored in the detection result storage sub-unit 1001.

For example, explanation is given on the case in which a different watermark information type from any of the watermark information types stored in the detection result storage sub-unit 1001 is detected by the digital watermark detection unit 305. The update sub-unit 1002 adds the newly detected watermark information type to the watermark information stored in the detection result storage sub-unit 1001, to update the detection record of all types of the watermark information.

In other words, each data contained in the detection record is shifted one place to the left, and only for the newly added watermark information type, the data “1” is recorded in the last place on the right, and for each of the watermark information types other than the newly detected type, the data “0” is recorded in the last place on the right.

On the other hand, description is made on the case in which the watermark information type corresponding to one of the watermark information types stored in the detection result storage sub-unit 1001 is detected by the digital watermark detection unit 305. The update sub-unit 1002 updates the watermark information detection record stored in the detection result storage sub-unit 1001.

In other words, each data contained in the detection record is shifted one place to the left, and only for the detected watermark information type, the data “1” is recorded in the last place on the right, and for each of the watermark information types other than the detected type, the data “0” is recorded in the last place on the right.

Finally, when no watermark information has been detected by the digital watermark detection unit 305, the update sub-unit 1002 updates the detection record stored in the detection result storage sub-unit 1001 (i.e. each data contained in the detection record is shifted one place to the left, and the data “0” is recorded in the last place on the right).

Thus, in the second embodiment, the update sub-unit 1002 updates the detection record for all types of the watermark information at once, without relation to which type of the watermark information has been detected. In other words, for the detected watermark information type, “1” is recorded, and for each of the other watermark information types, “0” is recorded in the last place on the right in the detection record. However, it is not necessary to update all types of the watermark information at once. For example, it is envisaged that, for the detected watermark information type, “1” is recorded, and for each of the other watermark information types, no update is performed.

### (3) Control Condition Judgment Sub-Unit 1003

The control condition judgment sub-unit 1003 serves to check the detection record stored in the detection result storage sub-unit 401 against the prescribed playback control condition, and judge whether the content is obtained by illegal acts, such as unauthorized copying.

More specifically, the control condition judgment sub-unit 1003 refers to the watermark information and the detection record stored in the detection result storage sub-unit 1001 with respect to each block, that is, a unit for detection, and when the referenced detection record satisfies the control condition, judges that the content is obtained by illegal acts, such as unauthorized copying. Since the playback control condition is similar to the first embodiment, explanation thereof will be omitted.

Note that, in the second embodiment, the control condition judgment sub-unit 1003 (i) refers to all the watermark information and the detection record with respect to each block, and (ii) when the detection record of any one of watermark information types satisfies the prescribed condition, instructs the control unit 307 to perform the operation corresponding to the watermark information type. In FIG. 11, in particular, the control condition judgment sub-unit 1003 judges, for each of three types of the watermark information, whether the playback control condition is satisfied. Then, if one of the three types of the watermark information satisfies the playback control condition, the control condition judgment sub-unit 1003 instructs the control unit 307 to perform the control corresponding to the watermark information type.

Meanwhile, the playback control condition may differ from some watermark information types to others, or may be the same for all the watermark information types. Like the first embodiment, the playback control condition may be varied dynamically.

Also, sometimes it happens that several types of the watermark information simultaneously satisfy the playback control condition. In such a case, the control condition judgment sub-unit 1003 determines one of the detected watermark information types, for which corresponding playback control is to be performed. The determination may be such that playback control corresponding to each watermark information type is performed in order of the priority, the priority being assigned to each watermark information type, for example.

The content playback/editing apparatus (digital watermark detection apparatus) 102 may pre-store a correspondence table of the watermark information type and the priority. Alternatively, each priority may be embedded in each watermark information piece as a part thereof (e.g. the greater the number indicating the type, the higher the priority).

Furthermore, the priority to be placed may be determined depending on the speculation of a content provider and a copyright holder, for example. It is thought that content providers who weigh copyright protection strictly would place a higher priority on the watermark information corresponding to a strict control, such as stopping the playback, whereas those who wish to suppress disadvantages to users would place a higher priority on the watermark information corresponding to a loose control, such as a warning display and stopping the audio only. Moreover, the priority is not necessarily static, and may be varied dynamically. For example, it is envisaged that the more the watermark information pieces of the identical type are detected, higher the priority of the type becomes.

Furthermore, it is not necessary to judge whether the playback control condition is to be satisfied based on the detection record of each watermark information type. It is also possible to set the playback control condition by combining several types of watermark information. As such, for example, it is envisaged that playback control is performed, when (i) the watermark information “000” has been “detected in two or more blocks in the past five blocks”, and (ii) the watermark information “001” has been further detected.

### (4) Control Unit 307

As mentioned above, the control unit 307 serves to control the playback of the content, in accordance with the judgment result made by the control condition judgment sub-unit 1003 of the judgment unit 306 as to whether the playback control condition is satisfied (i.e. whether the content is obtained by illegal acts, such as unauthorized copying). Since the actual operations of the control unit 307 are similar to the first embodiment, explanation thereof will be omitted.

### <2.3> Operations of the Judgment Unit 306

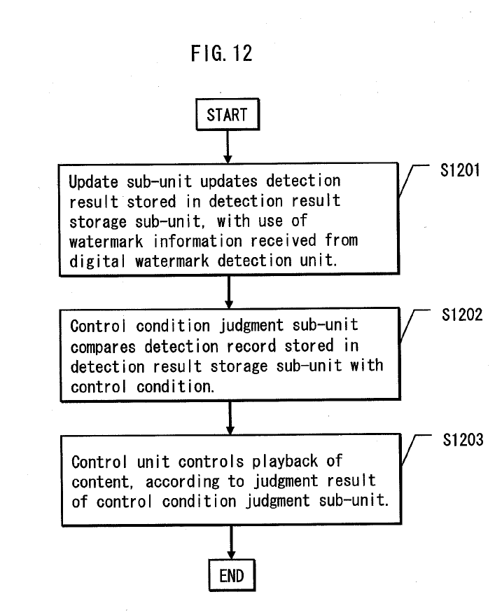

Description will be made on the operations of the judgment unit 306 with reference to FIG. 12.

The update sub-unit 1002 updates the detection result stored in the detection result storage sub-unit 1001, with use of the watermark information received from the digital watermark detection unit 305 (Step S1201). The control condition judgment sub-unit 1003 also judges whether the detection record stored in the detection result storage sub-unit 1001 satisfies the playback control condition (Step S1202). The control unit 307 then controls the playback of the content, according to a judgment result of the control condition judgment sub-unit 1003 (Step S1203).

It is also possible to reverse the order of the update of the detection record according to Step S1201 and the judgment as to whether the playback control condition is satisfied according to Step S1202.

### <2.4> Special Playback Operations by the Playback Block Selection Unit 1501

Description will be made on the special playback operations, providing that the digital watermark detected block storage unit 309 stores therein the blocks embedded with the watermark information.

The special playback is a playback method for circumventing playback control that is performed by the control unit 307. In the special playback in the present embodiment, the information indicating the watermark information detected blocks is used in order to circumvent playback control. In the description below, therefore, it is assumed that, due to the playback operations carried out in the past, one or more blocks in the content embedded with the watermark information have been already detected and that the watermark information detected blocks have been stored in the digital watermark detected block storage unit 309.

For that matter, in order to carry out the special playback, it is preferable that all the blocks embedded with the watermark information have been detected. However, it can be presumed that in the past the content was played back only halfway (or the control unit 307 stopped the playback in the middle). Accordingly, in the description below, it is further assumed that the digital watermark detected block storage unit 309 have stored the watermark information detected blocks with respect to not all but at least some of the blocks contained in the content in the present embodiment.

The special playback is carried out, when the content playback/editing apparatus (digital watermark detection apparatus) 102 receives a request from the user thereof. Without the request from the user, the content playback/editing apparatus (digital watermark detection apparatus) 102 performs playback as usual. Since such playback operations are similar to the first embodiment, explanation thereof will be omitted.

Firstly, upon receiving the request for the special playback, the recording medium access unit 301 reads, from the recording medium 103, the encrypted content key and the encrypted content (Step S1901).

Secondly, the content key decryption unit 303 decrypts the encrypted content key read from the recording medium 103, by means of the device key stored in the device key storage unit 302 (Step S1902). The playback block selection unit 1501 transfers, to the content decryption unit 305, all data other than the blocks stored in the digital watermark detected block storage unit 309, in each of which the watermark information has been detected (Step S1903). The transferred content is obtained by substantially removing, from the encrypted content read from the recording medium 103, the blocks stored in the digital watermark detected block storage unit 309.

The content decryption unit 304 decrypts the transferred content by means of the content key (Step S1904). The digital watermark detection unit 305 detects the watermark information from the audio part of the content obtained through the decryption in Step S1904 (Step S1905).

The judgment unit 306 judges whether the content is an unauthorized copy or such, based on the watermark information detected by the digital watermark detection unit 305 (Step S1906).

The digital watermark detected block storage unit 309 stores therein the watermark information detected by the digital watermark detection unit 305, the title ID that specifies the content data for which the detection has been performed, and the information that specifies the block of the content in which the watermark information has been detected (Step S1907).

In accordance with a judgment result of the judgment unit 306, the control unit 307 controls the output of the content (Step S1908), and when the control unit 307 permits playback, outputs the content to be played back to a display device, such as a monitor display (Step S1909).

As an actual processing in Step S1903, description will be made on the case where the digital watermark detected block storage unit 309 holds the information shown in FIG. 18.

FIG. 18 shows that, in the content data titled with the title ID “001”, three types of the watermark information has been found in four blocks. In this case, the playback block selection unit 1501 substantially removes some of the encrypted content data of the content data titled with the title ID “001”, located in the blocks corresponding to a period between 00:00:10 and 11:11:40 and a period between 00:03:30 and 00:03:40. The playback block selection unit 1501 transfers only the encrypted content data located in the remaining blocks to the content decryption unit 304.

According to the above special playback operations, when the content is played back, the blocks in which the watermark information has been detected are skipped. Asa result, playback control by the control unit 307, such as stopping the audio output and displaying a warning message, may be circumvented in the audio and the video to be output.

As a result, even if a children's birthday party with a movie content (such as an animation movie) audible in the background is recorded on a camcorder, and the audio embedded with copyright information has been inadvertently record thereon, the recorded audio data can be viewed, without the influence of playback control, such as displaying a warning and stopping the audio output.

Meanwhile, since the above description includes the case where the existence or non-existence of watermark information has not been confirmed for all the blocks, processing in Steps S1905 to S1907 is supposed to be performed, just like the case where the content is played back as usual.

If the existence or non-existence of watermark information has been confirmed for all the blocks, the watermark information is not detected in any block in Step S1905. Therefore, the data “0” is always recorded in Step S1907, indicating that no watermark information has been detected. In Step S1906, the content is always judged not to be an unauthorized copy. Namely, if the existence or non-existence of watermark information has been confirmed for all the blocks, the operations performed in Steps S1905 to S1907 are of substantially no significance.

Accordingly, as long as it can be acknowledged at the time of the special playback that the existence or non-existence of watermark information has been already confirmed for all the blocks, the operations of Steps S1905 to S1907 may be omitted. This may be realized, for example, by having the content playback/editing apparatus (digital watermark detection apparatus) 102 store the information indicating whether confirmation has been already made for all the blocks.

Beyond that, although in the second embodiment the playback block selection unit 1501 selects the blocks of the content to be played back based on the encrypted content, the present invention is not limited to this. As long as the blocks to be transferred may be selected appropriately in such a manner that no watermark information is contained therein, the selection may be based on something else.

For example, as another selection method, it is also possible to cause the playback block selection unit 1501 to select, from among the content that has been decrypted by the content decryption unit 304, the blocks to be played back, and transfer the selected blocks to the digital watermark detection unit 305.

This causes the content containing the watermark information not to be transferred to the digital watermark detection unit 305, which detects the watermark information to provide grounds for the judgment of playback control. As a result, users are able to view thus output content as usual, without the influence of playback control.

Moreover, although in Step S1903 in the second embodiment all the blocks stored in the digital watermark detected block storage unit 309 are substantially removed from the content prior to transference thereof, the present invention is not limited to this. It is also possible to select the blocks to be substantially removed by the playback block selection unit 1501, by causing the control unit 307 to refer to the playback control condition, so that the to-be-removed blocks are minimized within the range that does not trigger the control unit 307 to perform playback control.

More specifically, a similar selection method to the first embodiment may be used in which the digital watermark detected block deletion unit 310 selects the blocks to be substantially removed.

Furthermore, although in Step S1903 in the second embodiment all the blocks stored in the digital watermark detected block storage unit 309 are substantially removed from the content prior to transference thereof, the present invention is not limited to this. It is also possible to substantially remove, from the blocks stored in the digital watermark detected block storage unit 309, only the audio data embedded with the watermark information, and transfer all the video data, so as to circumvent playback control by the control unit 307. By doing this, users are able to view the content as usual except that the audio output temporarily stops. For, the video data remains as it is, and the control unit 307 does not playback control, including a warning display.

### SUMMARY

One aspect of the present invention is a content playback/editing apparatus that plays back and edits a content, comprising: a detection unit operable to detect digital watermark information in the content; a storage unit that stores therein the digital watermark information detected by the detection unit and information that specifies the blocks of the content in which the digital watermark information has been detected; and a content editing unit operable to edit the content in accordance with the information stored in the storage unit.

In the content playback/editing apparatus, the content editing unit may delete, from the content, the data corresponding to all the blocks stored in the storage unit, and combine the data located in the blocks previous and next to each of the deleted data.

In the content playback/editing apparatus, the content editing unit may (i) select, from among all the blocks stored in the storage unit, the blocks to be deleted, so that the to-be-deleted blocks are minimized within the range that does not satisfy a playback control rule defined by copyright protection standards, (ii) delete the data corresponding to the selected blocks, and (iii) combine the data located in the previous and next blocks to each of the deleted data.

In the content playback/editing apparatus, the content includes at least the audio data, and the content editing unit may delete only the audio data corresponding to the blocks specified by the information stored in the storage unit.

In the content playback/editing apparatus, the content includes at least the audio data, and the content editing unit may replace the audio data corresponding to the blocks specified by the information stored in the storage unit with other audio data.

Another aspect of the present invention is a content playback apparatus that plays back a content, comprising: a detection unit operable to detect digital watermark information in the content; a storage unit that stores therein the digital watermark information detected by the detection unit and information that specifies the blocks of the content in which the digital watermark information has been detected; and a content playback control unit operable to perform control on blocks to be played back in accordance with the information stored in the storage unit, at the time of the playback of the content.

In the content playback apparatus, the content playback control unit may perform control so that the blocks of the content specified by the information stored in the storage unit are not to be played back but skipped, at the time of the playback of the content.

The content includes at least the audio data, and the content playback control unit may perform control so that only the audio data corresponding to the blocks of the content specified by the information stored in the storage unit is not to be played back, at the time of the playback of the content.

Yet another aspect of the present invention is a content playback/editing method for playing back and editing a content, comprising the steps of: detecting digital watermark information from the content; storing the digital watermark information detected in the detecting step and information that specifies the blocks in which the digital watermark information has been detected; and editing the content in accordance with the information stored in the storing step.

Here in the content editing step, the data corresponding to all the blocks specified by the information stored in the storing step may be deleted from the content, and the data located in the previous and next blocks to each of the deleted data may be combined.

Here, the content editing step may include a deletion block selection step for selecting, from among all the blocks stored in the storing step, the blocks to be deleted, so that the to-be-deleted blocks are minimized within the range that does not satisfy the playback control condition defined by the copyright protection standards. Further, in the content editing step, only the data corresponding to the blocks selected in the deletion block selection step may be deleted from the content, and the data located in the previous and next blocks to each of the deleted data are combined.

In the content playback/editing method, the content includes at least the audio data, and in the content editing step only the audio data corresponding to the blocks specified by the information stored in the storage unit may be deleted.

In the content playback/editing method, the content includes at least the audio data, and in the content editing step the audio data corresponding to the blocks specified by the information stored in the storage unit may be replaced with other audio data.

Yet another aspect of the present invention is a content playback method for playing back a content, comprising the steps of: detecting digital watermark information from the content; storing the digital watermark information detected in the detecting step and information that specifies the blocks in which the digital watermark information has been detected; and performing control on blocks to be played back in accordance with the information stored in the storage unit, at the time of the playback of the content.

Here in the content playback control step for performing control on the blocks to be played back in the content playback method, the blocks of the content specified by the information stored in the storage unit may be controlled not to be played back but skipped, at the time of the playback of the content.

In the content playback method, the content includes at least the audio data, and in the content playback control step, it may be so controlled that only the audio data corresponding to the blocks of the content specified by the information stored in the storage unit is not played back, at the time of the playback of the content.

Yet another aspect of the present invention is a program for causing a computer to execute the content playback/editing method or the steps included in the content playback method.

With the above structures, the present invention makes it possible to perform processing, such as deleting blocks containing copyright protection information, even when the audio containing the copyright protection information is inadvertently recorded, thereby enabling users to view parts of the content that does not violate copyright protection.

### Modifications

Although the present invention has been described according to the above embodiments, it is natural that the present invention is limited to these embodiments. The following modifications are also within the scope of the present invention.

(1) In the first and second embodiments, the information stored in the digital watermark detected block storage unit 309 is held within the content playback/editing apparatus (digital watermark detection apparatus) 102. However, it is possible to store, in the recording medium, information equivalent to that stored in the digital watermark detected block storage unit 309, and read the stored information from the recording medium at the time of playback, and perform processing of Steps S906 and S1903.

This allows a different device from the device by which watermark information detection was performed to grasp the blocks in the content embedded with the watermark information. Namely, by referring to the information stored in the recording medium 103, it is possible for the different device to acknowledge the whereabouts of the blocks in which the watermark information has been embedded, without performing watermark information detection on its own. As a result, even when playing back the content in the recording medium for the first time, the different device is able to perform editing and the special playback straight away without performing watermark information detection processing.

(2) Although in the second embodiment the playback block selection unit 1501 selects the blocks of the content that are to be played back, in accordance with the information stored in the digital watermark detected block storage unit 309, the to-be-played-back blocks once selected by the playback block selection unit 1501 may be stored in the recording medium 103 as navigation information.

Generally, a content stored in the recording medium 103, such as a DVD (Digital Versatile Disc) and a BD (Blu-ray Disc), is played back in accordance with navigation information and a playlist stored in the recording medium 103 in advance. Therefore, it is also possible to update the navigation information and the playlist, so that only the to-be-played-back blocks selected by the playback block selection unit 1501 are played back, in conformity with an application format applied to the content stored in the recording medium 103.

In this case, it is not necessary to perform content decryption processing and watermark information detection processing in order to obtain the information that is stored in the digital watermark detected block storage unit 309 in advance. It is sufficient to play back the content according to the updated navigation information and the updated playlist, in order to view the content without the influence of playback control by the control unit 307.

(3) Although in the first and second embodiments the digital watermark detected block storage unit 309 stores therein information relating only to the recording medium 103 inserted in the content playback/editing apparatus (digital watermark detection apparatus) 102, the present invention is not limited to this. The digital watermark detected block storage unit 309 may store therein the digital watermark detected blocks that have been detected in a plurality of the recording media 103.

In such a case, it is necessary to store, for each of the recording media, the digital watermark detected blocks separately. Therefore, it is necessary to store, for each of the recording media, recording medium identification information that identifies each recording medium, in combination with the information shown in FIG. 16 and FIG. 18. By doing so, the following advantageous effect may be achieved. That is, as long as watermark information detection is performed for the content stored in one of the recording media only once, and the watermark information detected blocks thereof have been stored, the watermark information detection processing may be omitted at the time of playback for the second time or later.

(4) Although in the first and second embodiments the content is stored on the recording medium 103 (such as an optical disc), the present invention is not limited to this. For example, the content may be distributed via the network, or distributed in the form of a memory card that stores therein the content. Further, the encrypted content key and the encrypted content do not need to be provided via an identical distribution means. For example, it is envisaged that the encrypted content key is distributed via the network and that the encrypted content is distributed in the form of an optical disc or such that stores thereon the encrypted content.
(5) Although in the first and second embodiments the content data generation apparatus (digital watermark embedding apparatus) 101 and the content playback/editing apparatus (digital watermark detection apparatus) 102 are each consist of a single apparatus, the present invention is not limited to this. For example, functional parts of each of the content data generation apparatus (digital watermark embedding apparatus) 101 and the content playback/editing apparatus (digital watermark detection apparatus) 102 may be incorporated into a plurality of apparatuses in a dispersed manner. For example, each of the characteristic functions of the present invention may be realized in a plurality of separate apparatuses, such as a content editing apparatus that exclusively edits the content, and a content playback apparatus that exclusively includes a special playback function.
(6) Although in the first and second embodiments the content embedded with the digital watermark is encrypted, the present invention is not limited to this. For example, the content may be stored or transmitted without being encrypted. Or, even with encryption, it is not necessary to encrypt the content key using the device key, and encrypt the content using the content key. Further, new keys may be introduced to increase the number of levels of hierarchy. Alternatively, the device key may be used to encrypt the content directly, to decrease the number of levels of hierarchy. Furthermore, it is also possible to encrypt the content after modifying the values of the keys by using other data.
(7) Although in the first and second embodiments the control unit 307 controls the playback of the content, the present invention is not limited to this. For example, the control unit 307 may control not the playback but the processing of the content, such as outputting, transmitting, copying, and transferring, in accordance with the watermark information stored in the detection result storage unit.

In this case, too, the control unit may interrupt each processing (outputting, transmitting, copying, and others) when the watermark information detection record satisfies a prescribed condition (which corresponds to the playback control condition in the first and second embodiments). Again, in this case as well, it is possible to edit the content as in the first embodiment, or skip the blocks in which the watermark information has been detected as in the second embodiment during each processing (which corresponds to playback in the second embodiment and to copying in the present modification). By doing so, the benefits of users and copyright protection may become compatible.

(8) Although in the first and second embodiments the watermark information is embedded in the audio part, the present invention is not limited to this. Even if the watermark information is embedded in the video part, playback is possible in which the blocks embedded with the watermark information are deleted, by the processing described in the first or second embodiment.

In addition, when the watermark is embedded in the video part, several types of the watermark information may be embedded in the identical block by a plurality of embedding parts in the block. In this case, “1” may be recorded simultaneously for each of the several types of the watermark information in the watermark information detection record of the second embodiment.

(9) Although in the first and second embodiments, watermark information detection is performed at the time of the playback of the content, the present invention is not limited to this. Watermark information detection itself is possible only if content decryption and watermark information detection processing is carried out. Accordingly, when the content playback/editing apparatus (digital watermark detection apparatus) 102 reads the recording medium 103 for the first time, for example, the following pre-processing may be performed. The pre-processing is, for example, content decryption, watermark information detection, and storing the detection record.

Further, depending on a capability of the content playback/editing apparatus (digital watermark detection apparatus) 102, the processing of reading the encrypted content from the recording medium 103, content decryption, watermark information detection, and storing the detection record may be performed at a reasonably high speed, compared with a speed at which the content is played back.

In this case, by reading data prior to the playback thereof, the detection record may be stored in parallel with the playback of the content. In other words, by performing, in advance of the progress of the playback of the content, reading of the encrypted content, content decryption, watermark information detection, and storage of the detection record, watermark information detection record may be recorded simultaneously with the playback of the content.

Further, when performing the prior reading, it can be predicted, from the watermark information detection record stored in the prior reading, whether playing back one block ahead (or two or more blocks ahead) of a current playback block in the content would satisfy the playback control condition. Accordingly, besides the processing as in the first and second embodiments, the processing is available in which the blocks, which are predicted to satisfy the playback control condition when being played back, are skipped right before being played back.

(10) Although in the first and second embodiments the playback control condition and update condition are predetermined and static, the present invention is not limited to this. Those conditions may be varied. In this case, the playback control condition and update condition may be stored in the recording medium 103, or input by a user or an outside server.
(11) Although in the first and second embodiments the watermark information detection record is stored in the form of a table as shown in FIG. 5 and FIG. 18, the present invention is not limited to this. “0” and “1”, which indicate the existence or non-existence of the watermark information, may be reversed, and each data may be shifted one place not to the left but to the right. It is also possible to use data in a non-table form.

Further, the number of blocks stored as the detection record is not limited to five. However, the number of blocks must be large enough to make it possible to confirm whether the playback control condition is satisfied. Furthermore, the number of blocks stored as the detection record does not need to be static, and may be varied according to the playback control condition.

For example, it is possible to change the number of blocks stored as the detection record in accordance with the number of blocks required for the playback control condition. More specifically, if the playback control condition is switched from “the digital watermark information has been detected in more than two blocks in the past five blocks” to “the digital watermark information has been detected in three consecutive blocks”, it is suffice to store three blocks as the detection record. Accordingly, here the number of the blocks stored as the detection record is changed to three, for example.

(12) Although editing processing is performed in the first embodiment and special playback processing is performed in the second embodiment, the present invention is not limited to this. It is also possible to perform the special playback, when the detection record is stored with respect to one type of the watermark information as in the first embodiment. It is also possible to perform the editing processing, when the detection record is stored with respect to several types of the watermark information as in the second embodiment.
(13) Although in the first embodiment the editing operations are always performed upon reception of a request for editing, and in the second embodiment the special playback operations are performed upon reception of a request for the special playback, the present invention is not limited to this. For example, such processing as editing and the special playback may be rejected, if the content is judged, from the record by the digital watermark detected block storage unit, to be highly likely to have been obtained by illegal acts, such as unauthorized copying. Standards on which the content is judged to be highly likely to be an unauthorized copy includes the following: whether the watermark information has been detected in more blocks than a predetermined threshold; whether the watermark information has been detected more often than a predetermined frequency (frequency here means the number of digital watermarks detected in a predetermined number of blocks); and whether the watermark information has been detected at a greater rate than a predetermined ratio against a total number of blocks included in the whole content.
(14) Although in the first and second embodiments the digital watermark is embedded in a digital content, the present invention is not limited to this. Naturally, the present invention is applicable when the digital watermark is embedded in an analog data.
(15) Part or all of the compositional elements of each apparatus may be composed of a removable IC card or a single module. The IC card or the module is a computer system composed of a microprocessor, a ROM, a RAM, or the like. The IC card or the module may be included the aforementioned super-multifunctional LSI. The IC card or the module achieves its functions by the microprocessor operating according to computer program. The IC card or the module may be tamper-resistant.
(16) The present invention may be methods shown by the above. Furthermore, the methods may be a computer program realized by a computer, and may be a digital signal of the computer program.

Furthermore, the present invention may be a computer-readable recording medium such as a flexible disk, a hard disk, a CD-ROM, an MO, a DVD, a DVD-ROM, a DVD-RAM, a BD (Blu-ray Disc) or a semiconductor memory, that stores the computer program or the digital signal. Furthermore, the present invention may be the computer program or the digital signal recorded on any of the aforementioned recording media.

Furthermore, the present invention may be the computer program or the digital signal transmitted on an electric communication network, a wireless or wired communication network, a network of which the Internet is representative, or a data broadcast.

Furthermore, the present invention may be a computer system that includes a microprocessor and a memory, the memory storing the computer program, and the microprocessor operating according to the computer program.

Furthermore, by transferring the program or the digital signal to the recording medium, or by transferring the program or the digital signal via a network or the like, the program or the digital signal may be executed by another independent computer system.

(17) The present invention may be any combination of the above-described embodiments and modifications.

### INDUSTRIAL APPLICABILITY

The a content playback/editing apparatus (digital watermark detection apparatus) described above can be used managerially, in other words, can be used repeatedly and continuously, in the industry which provides contents to users, in the manufacturing industry which manufactures apparatuses for playing back digital contents, and in the selling industry which sells apparatuses for playing back digital contents.

1-12. (canceled)

13. A content playback apparatus, comprising:
a detection unit operable to detect a digital watermark from audio data having a plurality of blocks, the audio data being contained in a content which is to be played back along a playback time-line;
a playback unit operable to play back the content; and
a playback control unit operable to control the playback unit to execute (i) a first playback control when a detection result of the digital watermark satisfies a prescribed condition, and (ii) a second playback control instead of the first playback control under instruction to circumvent the first playback control, wherein
the second playback control is executed so that
(i) a block is selected from among blocks in each of which the digital watermark has been detected, the block to be selected being indispensable for the prescribed condition to be satisfied, and
(ii) all data contained in the content is played back other than audio data corresponding to the selected block.

14. The content playback apparatus of claim 13, wherein
when the second playback control is executed,
the playback control unit deletes the audio data corresponding to the selected block, and
the playback unit plays back all data contained in the content other than the deleted audio data.

15. The content playback apparatus of claim 13, wherein
when the second playback control is executed,
the playback control unit replaces the audio data corresponding to the selected block with other audio data, and
the playback unit plays back the other audio data and all data contained in the content other than the replaced audio data.

16. The content playback apparatus of claim 13, wherein
the second playback control is executed to control the playback unit to play back all data contained in the content other than the audio data corresponding to the selected block by skipping the audio data.

17. The content playback apparatus of claim 13, wherein
the prescribed condition is that, in a predetermined number of timely consecutive blocks, the digital watermark has been detected in more blocks than a predetermined threshold, and
the second playback control is executed so that one or more blocks are selected from among the predetermined number of blocks, in such a manner that a number of the selected blocks is greater than or equal to a difference between the number of the blocks in each of which the digital watermark has been detected and the predetermined threshold.

18. A content playback apparatus, comprising:
a detection unit operable to detect a digital watermark from audio data having a plurality of blocks, the audio data being contained in a content which is to be played back along a playback time-line;
a playback unit operable to play back the content; and
a playback control unit operable to control the playback unit to execute (i) a first playback control when a detection result of the digital watermark satisfies a prescribed condition, and (ii) a second playback control instead of the first playback control under instruction to circumvent the first playback control, wherein
the second playback control is executed so that
all data contained in the content is played back other than audio data corresponding to blocks in each of which the digital watermark has been detected.

19. A content playback method for use in a content playback apparatus, comprising the steps of:
detecting a digital watermark from audio data having a plurality of blocks, the audio data being contained in a content which is to be played back along a playback time-line;
playing back the content; and
controlling the playback unit to execute (i) a first playback control when a detection result of the digital watermark satisfies a prescribed condition, and (ii) a second playback control instead of the first playback control under instruction to circumvent the first playback control, wherein
the second playback control is executed so that
(i) a block is selected from among blocks in each of which the digital watermark has been detected, the block to be selected being indispensable for the prescribed condition to be satisfied, and
(ii) all data contained in the content is played back other than audio data corresponding to the selected block.

20. A computer readable recording medium that stores therein a computer program for use in a content playback apparatus, wherein
the computer program includes:
detecting a digital watermark from audio data having a plurality of blocks, the audio data being contained in a content which is to be played back along a playback time-line;
playing back the content; and
controlling the playback unit to execute (i) a first playback control when a detection result of the digital watermark satisfies a prescribed condition, and (ii) a second playback control instead of the first playback control under instruction to circumvent the first playback control, wherein
the second playback control is executed so that
(i) a block is selected from among blocks in each of which the digital watermark has been detected, the block to be selected being indispensable for the prescribed condition to be satisfied, and
(ii) all data contained in the content is played back other than audio data corresponding to the selected block.

21. An integrated circuit, comprising:
a detection unit operable to detect a digital watermark from audio data having a plurality of blocks, the audio data being contained in a content which is to be played back along a playback time-line;
a playback unit operable to play back the content; and
a playback control unit operable to control the playback unit to execute (i) a first playback control when a detection result of the digital watermark satisfies a prescribed condition, and (ii) a second playback control instead of the first playback control under instruction to circumvent the first playback control, wherein
the second playback control is executed so that
(i) a block is selected from among blocks in each of which the digital watermark has been detected, the block to be selected being indispensable for the prescribed condition to be satisfied, and
(ii) all data contained in the content is played back other than audio data corresponding to the selected block.
